(19) United States
(12) Patent Application Publication
(10) Pub. No.: US 2026/0238656 A1
(43) Pub. Date: Aug. 13, 2026

(54) Systems and Methods for Hybrid Quantum-Classical Network Traffic Classification and Filtering

(71) Applicant: Salesforce, Inc., San Francisco, CA (US)

(72) Inventors: Simone MAINARDI, Dublin (IE); Kaushal BANSAL, Alamo, CA (US); Prabhat SINGH, San Jose, CA (US)

(21) Appl. No.: 19/211,563

(22) Filed: May 19, 2025

Related U.S. Application Data
(60) Provisional application No. 63/757,468, filed on Feb. 12, 2025.

(51) Int. Cl. H04L 9/40; G06N 10/60; H04L 41/16

(52) U.S. Cl. CPC H04L 63/1416; G06N 10/60; H04L 41/16

(57) ABSTRACT

A device may determine a plurality of training data observations corresponding to a plurality of application-layer request messages received at the computing system, the plurality of training data observations including a plurality of fingerprint values determined based on content associated with the plurality of application-layer request messages, a first subset of the plurality of application-layer request messages being classified as malicious, a second subset of the plurality of application-layer request messages being classified as legitimate. A device may determine a classical support vector machine based on a quantum kernel, the quantum kernel being determined based on a quantum feature map and a plurality of quantum states, the quantum feature map embedding the plurality of fingerprint values into a quantum space corresponding to the quantum states. A device may determine a fingerprint value for an application-layer request message received at an application gateway within the computing system.

### CROSS-REFERENCE TO RELATED APPLICATIONS

This application claims priority to Provisional U.S. Patent Application 63/757,468 (Attorney Docket SFDCP256P), filed Feb. 12, 2025 by Mainardi et al., titled “Systems and Methods of Entropy- And Locality-Based Fingerprinting for Botnet Traffic Classification,” which is incorporated herein by reference in its entirety and for all purposes.

### FIELD OF TECHNOLOGY

This patent application relates generally to network attack detection and mitigation, and more specifically to application layer defense of a shared infrastructure.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. For example, users may interact with website hosting services implemented in cloud comp environments to access websites and/or other services associated with domains. Such interactions may be conducted via any of various types of devices, such as mobile devices and/or computer systems.

Cloud computing services are vulnerable to Distributed Denial of Service (DDoS) attacks and other types of network attacks. Many of these attacks occur at the application layer of the network stack. Platforms that expose autonomous AI agents to public access present particular challenges, since such platforms may not necessarily be protected by a login mechanism. The implementation of autonomous AI agents often involves considerable resource expenditure. Accordingly, malicious requests sent to autonomous AI agent platforms can be particularly disruptive to computing service providers and to recipients of services provided by such computing service providers. Given the prevalence and disruptiveness of network attacks such as application-layer DDoS attacks, improved techniques for detecting and mitigating network attacks are desired.

### BRIEF DESCRIPTION OF THE DRAWINGS

The included drawings are for illustrative purposes and serve only to provide examples of possible structures and operations for the disclosed inventive systems, apparatus, methods, and computer program products for network traffic classification and filtering via fingerprinting. These drawings in no way limit any changes in form and detail that may be made by one skilled in the art without departing from the spirit and scope of the disclosed implementations.

FIG. 1 illustrates a traffic filtering overview method, performed in accordance with one or more embodiments.

FIG. 2 illustrates a computing system, configured in accordance with one or more embodiments.

FIG. 3 illustrates additional elements of the computing system, configured in accordance with one or more embodiments.

FIG. 4 shows a block diagram of an example of an environment that includes an on-demand database service configured in accordance with some implementations.

FIG. 5A shows a system diagram of an example of architectural components of an on-demand database service environment, configured in accordance with some implementations.

FIG. 5B shows a system diagram further illustrating an example of architectural components of an on-demand database service environment, in accordance with some implementations.

FIG. 6 illustrates one example of a computing device, configured in accordance with one or more embodiments.

FIG. 7 illustrates a domain onboarding and fingerprint generation method, performed in accordance with one or more embodiments.

FIG. 8 illustrates a method of determining training data, performed in accordance with one or more embodiments.

FIG. 9 illustrates a method of determining a trained traffic classification model, performed in accordance with one or more embodiments.

FIG. 10 illustrates a method of applying the trained classification model, performed in accordance with one or more embodiments.

FIG. 11 illustrates a method of filtering traffic, performed in accordance with one or more embodiments.

FIG. 12 illustrates a method for determining a traffic classification hybrid quantum-classical support vector machine, performed in accordance with one or more embodiments.

FIG. 13 illustrates a quantum feature map, configured in accordance with one or more embodiments.

### DETAILED DESCRIPTION

### Introduction

Techniques and mechanisms described herein provide for network traffic classification and filtering via fingerprinting. A computing system may expose a communication specification governing application-layer request messages transmitted to the computing system. Some of the traffic received at the computing system may comply with this specification, while other traffic may not. The traffic that does not comply with the communication specification may be treated as presumptively malicious, for instance originating from a botnet. Such malformed request may be used to determine a first set of fingerprints to use for training purposes. These training fingerprints may then be used to train a machine learning model for classifying other requests as malicious. The trained machine learning model may be applied to a set of requests, for instance on a periodic basis, to identify a set of suspicious requests. A second set of fingerprints may be determined for these suspicious requests for use in filtering traffic. These filter fingerprints may then be shared with application gateways and used to filter subsequent traffic that does comply with the communication specification. For instance, an otherwise well-formed request that complies with the communication specification but that has a fingerprint matching, or sufficiently similar to, one associated with a filter fingerprint may be blocked.

In today's cybersecurity landscape, the increasing frequency and complexity of Layer 7 Distributed Denial of Service (L7 DDoS) attacks demand advanced defensive strategies. Layer 7 refers to the top layer in the 7-layer Open Systems Interconnection (OSI) Model of the Internet. It is also known as the “application layer.” Layer 7 is the top layer of the data processing that occurs just below the surface or behind the scenes of software applications.

For example, login requests, HTTP requests and responses used to load webpages, and other such high-level messages are layer 7 events. An L7 DDoS attack is a strategy that involves sending many malicious application-layer requests in an effort to overwhelm recipient web servers and undermine the services that they provide.

L7 DDoS attacks are particularly challenging to address because responding to an application layer message typically requires many more resources than transmitting an application layer request. For example, sending a login request or a webpage request typically involves few resources and limited network traffic, while operations such as processing a login request, generating a webpage, and sending a webpage typically involve many more processing and network resources. As another example, sending a request to an autonomous AI agent exposed via an agent platform also typically requires minimal resources and limited network traffic, while operations such as instantiating and executing an autonomous AI agent may involve significant resource expenditure, potentially involving multiple interactions with a large language model among other actions. This discrepancy in resource utilization also makes L7 DDoS attacks are particularly attractive to attackers.

Attacks targeting the application layer significantly jeopardize the continuity and reliability of services and infrastructure. Conventional solutions often rely on manual intervention, where engineers review attack event data and correlate it with historical trends and data to distinguish genuine traffic increases from malicious L7 DDoS activities. The overall handling of an incident requires additional steps that again heavily lean on human intervention. These manual methods are not only prone to errors but also demand substantial time and resources. For example, the process of addressing these incidents requires the coordination of multiple teams across incident response bridges, significantly increasing the operational costs associated with detection and remediation. More critically, these incidents can have a profound impact on business operations and erode customer trust, posing substantial risks to long-term business sustainability and customer relationships.

Many conventional approaches for addressing L7 DDoS attacks suffer from various deficiencies. For example, rate limiting-based solution for limiting attack traffic, such as Ngnix, typically do not differentiate the benign traffic or attack traffic during rate limiting and require significant manual configuration. For a deployment where hundreds of thousands of domains are hosted, using such a solution is impractical and due to the significant manual intervention needed, which would lead to delays in detection and require significant resources. As another example, conventional public cloud DDoS solutions typically do not support specific policies for traffic directed to particular domains and do not support precise detection and mitigation actions. Such limitations again make these solutions ineffective and require significant manual intervention. Commercial DDoS solutions often rely on limited, current traffic data to make decisions and have high chances of false positives and disrupting benign customer traffic during the attack.

Volumetric approaches provide effective protection against large-scale volumetric DDoS attacks. However, volumetric approaches typically rely on volumetric thresholds for attack detection. When using a predetermined traffic volume threshold, DDoS attacks that stay below the predetermined traffic volume threshold can bypass the system undetected, leaving the computing system vulnerable. Although various systems offer data path protection capabilities and provide for volumetric attack detection and mitigation, the overall system's effectiveness is constrained by its reactive nature if its defenses are primarily volumetric in nature, operating in an on-demand, reactive mode.

To address such challenges, various embodiments described herein provide for a robust system capable of swiftly detecting, evaluating, and countering L7 DDoS threats with minimal manual input. Automated and intelligent decision-making is harnessed to enhance accuracy, reduce response times, and lower the reliance on extensive human involvement in the threat mitigation process. The system directly addresses the rising frequency and complexity of Layer 7 Distributed Denial of Service (L7 DDoS) attacks. Unlike conventional solutions that depend heavily on manual intervention and retrospective analysis-approaches that are not only time-consuming and resource-intensive but also prone to inaccuracies-techniques and mechanisms described herein provide for automated detection, evaluation, and mitigation of L7 DDoS threats.

According to various embodiments, by integrating intelligent decision-making algorithms that analyze real-time traffic and historical data, the system can respond not only to volumetric attacks, but can also isolate and reject malicious requests that are not volumetric in nature. The system's capacity to autonomously implement countermeasures significantly reduces the risk to service continuity and infrastructure reliability. Thus, techniques and mechanisms described herein improve the functioning of cloud computing platforms, reduce the operational burden on cybersecurity teams, enhance the accuracy of threat detection and mitigation, and preserve the integrity of digital services against the backdrop of an evolving threat landscape.

Various embodiments described herein also relate to botnet traffic classification using entropy and locality-based fingerprinting methods. The system employs a novel family of fingerprints that leverage entropy and locality-sensitive hashing to analyze features of traffic connections (e.g., HTTP).

In some embodiments, a fingerprinting methods involve i) extracting traffic features such as User-Agent, Server Name, and URL from the connections; ii) computing the n-grams of the extracted features and/or; iii) calculating the entropy and locality-sensitive hashed digests on the feature n-grams. The resulting fingerprints can be used to classify traffic as either legitimate or suspicious botnet traffic.

In some embodiments, the fingerprints can detect casual or automated requests, ensure similar requests yield similar fingerprints, and maintain low computational complexity. This approach enhances the performance of machine learning models in categorizing traffic. Unlike existing fingerprints such as JA3 and JA4, the proposed fingerprints preserve the locality of data, simplifying the clustering of similar fingerprints and improving overall detection accuracy.

Botnets are widely used to attack internet resources or gather information for competitive data analysis and market research. In particular, if an agent platform for providing AI agents is attacked by botnets, the attack can lead to higher resource utilization and potential exposure to OWASP attacks. Capturing casual or automated requests is crucial to protect against attacks such as model denial of service attacks, improper input validation, data exposure, and credential stuffing. Empirical observations and available data suggest that botnet traffic differs significantly from legitimate user traffic. For instance, botnets often exhibit repetitive patterns, such as very short inter-request times, and perform automated requests when enumerating resources. These requests often attempt to breach resources by trying known URL patterns with minor variations and randomizing connection fields. In essence, botnet requests generally contain a higher degree of randomness in some cases, while tending to be similar with small variations in other cases.

These observations highlight the limitations of existing fingerprints like JA3 and JA4, which do not adequately capture the randomness and generate completely different fingerprints for nearly identical requests. Accordingly, existing fingerprinting methods, such as JA3 and JA4, fall short in effectively distinguishing between legitimate traffic and botnet traffic. Botnet traffic, or traffic believed, suspected, or classified as potentially botnet traffic, is alternatively referred to herein as traffic that is malicious or suspicious. These methods often fail to capture the inherent randomness and subtle variations in botnet requests, resulting in completely different fingerprints for nearly identical requests. This limitation hampers the ability to accurately classify and mitigate botnet traffic, leaving systems vulnerable to sophisticated automated attacks. There is a critical need for a more robust and efficient fingerprinting method that can accurately detect and classify botnet traffic while maintaining low computational complexity. In contrast to conventional techniques, various embodiments described herein can account for captures the randomness in botnet requests and ensuring that similar requests yield similar fingerprints, thereby enhancing the performance of machine learning models in categorizing traffic.

To address these limitations, described herein is a novel family of fingerprints that incorporate entropy to capture requests with a higher degree of randomness and locality-sensitive hashing to ensure that similar requests yield similar hashes. This approach is highly effective at distinguishing legitimate traffic from suspicious botnet traffic. In one example, a classification using a Random Forest machine learning model demonstrates a 99% accuracy rate.

According to various embodiments, some fingerprints computed as discussed herein may be capable of detecting casual or automated requests (hence, high-entropy). Other fingerprints may ensure that that similar requests yield similar fingerprints, which is referred to as exhibiting locality sensitivity. Such fingerprints may also have a low complexity for computation. Ensuring that similar requests yield similar fingerprints allows clustering requests together when they have small variations. This, unlike JA3 or JA4, allows fingerprints described herein to find similarities with low complexity using Machine Learning models, vector databases and locality sensitive hashing, among others.

In some embodiments, fingerprints described herein may be determined based at least in part on Shannon entropy to capture the amount of uncertainty or randomness in a data source. Additionally, the MinHash provides a probabilistic technique and data structure used to find an approximation of the Jaccard similarity between sets with low complexity.

According to various embodiments, various types of fingerprints may be employed. For example, MinHash-Based Fingerprints (MH) employ MinHash techniques to approximate the Jaccard similarity between sets, enabling efficient similarity detection. As another example, Entropy-Based Fingerprints (HX) employ Shannon entropy to measure the randomness or uncertainty in data. As yet another example, Content-Based Fingerprints (CB) focus on specific traffic features such as User-Agent, Server Name, and URI.

In some embodiments, the system may facilitate holistic training data creation. Training data can be curated using URLs, where non-API-adhering URLs are marked as suspicious and API-adhering URLs as legitimate. This clear distinction can provide a foundation for accurate classification.

In some embodiments, the system may facilitate comprehensive request fingerprinting. Beyond just the URL, multiple request features such as User-Agent, Server Name, and other connection fields can be captured. Thus, even if a bad actor sends a good URL, other request components can still contribute to identifying the request as suspicious.

In some embodiments, the system may facilitate entropy and locality-sensitive hashing. By integrating entropy to measure randomness and locality-sensitive hashing to ensure similar requests yield similar fingerprints, both the randomness and subtle variations in botnet traffic can be captured.

In some embodiments, the system may facilitate machine learning integration: Fingerprints can be used to train a random forest machine learning model to identify patterns and anomalies. Thus, even if a bad actor sends a good URL, the model can detect inconsistencies in other request features, maintaining high classification accuracy.

In some embodiments, the system may demonstrate high accuracy. Demonstrating a 99% accuracy rate in one example, the system leverages the combined power of entropy, locality-sensitive hashing, and machine learning to provide a robust solution for botnet traffic classification.

Thus, the various embodiments provide for a holistic and multi-faceted approach to fingerprinting traffic, capturing a wide range of request features, and utilizing advanced techniques to ensure accurate and efficient classification of botnet traffic.

Techniques and mechanisms described herein also relate to hybrid quantum-classical data processing. According to various embodiments, traffic classification may be performed network fingerprinting, combined with quantum circuits and machine learning. A quantum circuit may be used to map network fingerprints of features of traffic connections (e.g., HTTP) into a high-dimensional space of quantum states. Machine learning may then applied in this high-dimensional space, where it can more easily separate legitimate and suspicious network traffic.

In some embodiments, the hybrid quantum-classical classification involves computing fingerprints, such as entropy and MinHash, from traffic features such as User-Agent, Server Name, and URL. A quantum feature map may then be used to embed the fingerprints into a high-dimensional quantum space. A kernel-based support vector machine (SVM) may then be trained on this quantum space to classify legitimate vs. suspicious traffic. The resulting hybrid quantum-classical classification demonstrates very good accuracy even when run on a quantum computer simulator.

Quantum feature maps can encode data into a much larger Hilbert space than classical feature maps. This capability helps in separating classes that are not easily distinguishable in classical space. For example, a 50-qubit quantum system can span a feature space having approximately 10¹⁵ dimensions, something that classical SVMs cannot achieve. In addition, while classical feature maps require explicitly computing high-dimensional features, quantum feature maps implicitly encode exponentially large feature spaces by leveraging quantum entanglement, which can lead to significant speedups in classification tasks in one or more embodiments.

According to various embodiments, the hybrid quantum-classical botnet traffic classification method provides scalability and performance improvements. With real-world datasets, hybrid quantum-classical botnet traffic classification provides potentially order-of-magnitude gains in model classification performance and/or speed. Even with a reduced dataset size, a quantum classification model may outperform classical classification methods. Thus, quantum-classical botnet traffic classification can facilitate unprecedented accuracy and speed in identifying and mitigating botnet traffic, providing efficient and robust protection against sophisticated attacks.

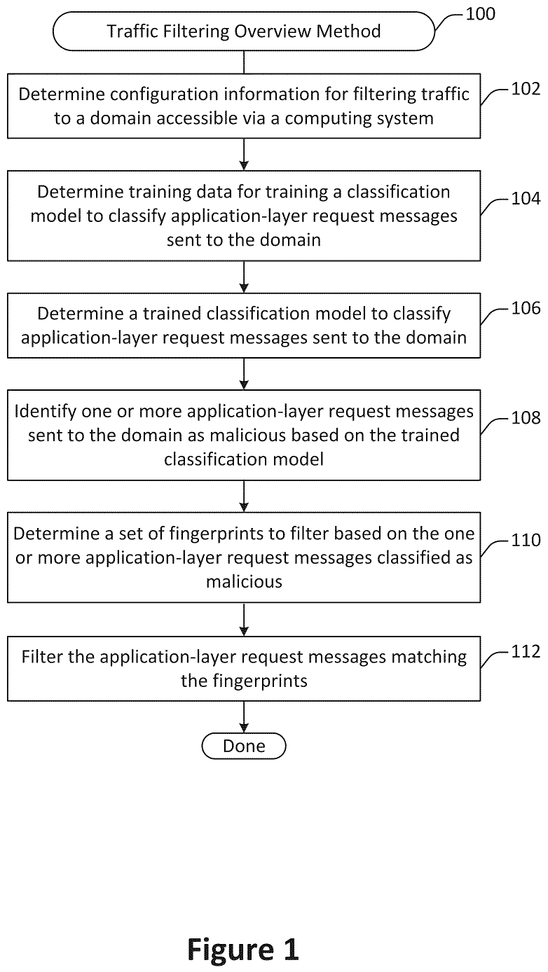

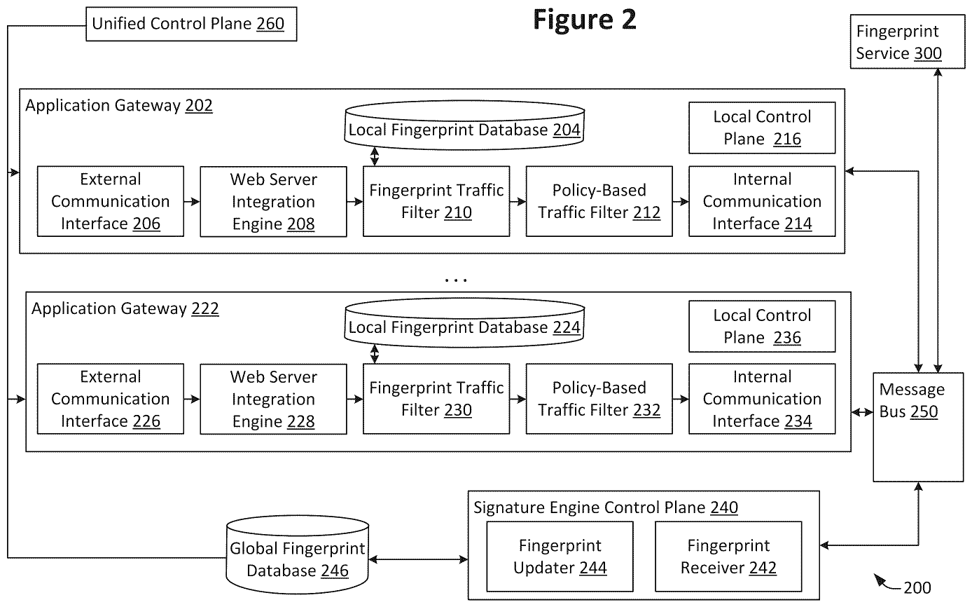

FIG. 1 illustrates a traffic filtering overview method 100, performed in accordance with one or more embodiments. The method 100 may be performed at a computing system providing computing services to various entities, and may be performed to filter traffic received at such a computing system. Additional details regarding elements of such a computing system are shown in FIG. 2 through FIG. 6.

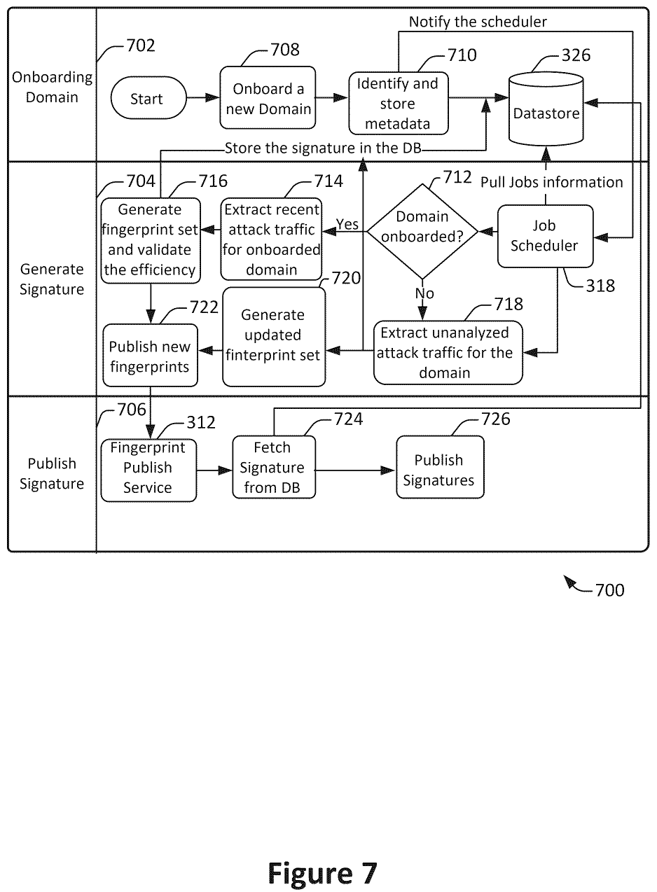

Configuration information for filtering traffic to a domain accessible is identified at 102. According to various embodiments, determining the configuration information may involve, for instance, identifying and storing various metadata information for the domain and determining an initial set of signatures for the domain. Additional details regarding the onboarding of a domain are discussed with respect to the method 700 shown in FIG. 7.

Training data for training a classification model to classify application-layer request messages as malicious is determined at 102. In some embodiments, the training data may be determined by performing a rough classification of request messages received at the system. Alternatively, training data may be identified in another way.

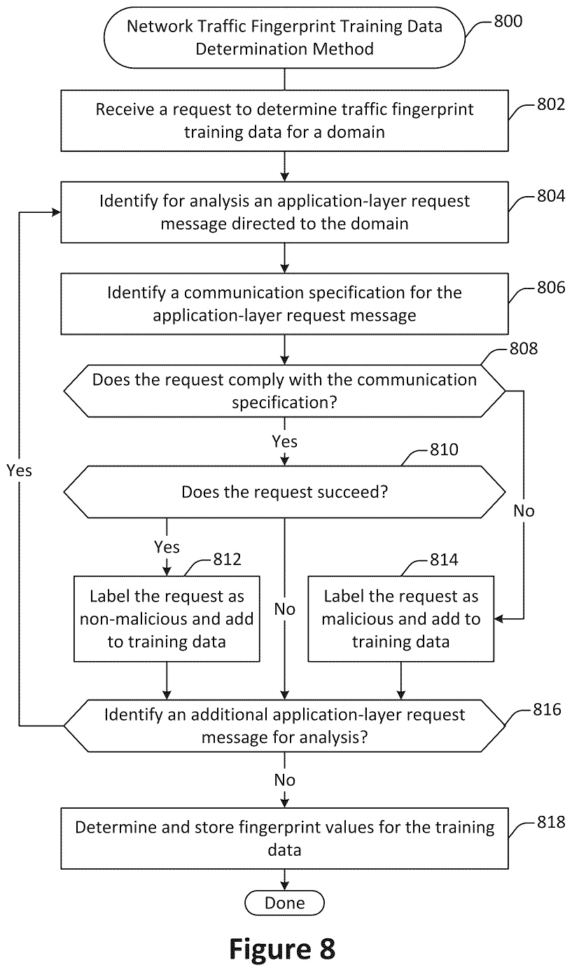

According to various embodiments, various criteria may be used to perform the rough classification. For example, request messages that fail to comply with a communication specification may be presumptively identified as malicious. As another example, request messages that both comply with a communication specification and that are successfully addressed by the computing system may be identified as not malicious. As another example, request messages that comply with the communication specification but that ultimately fail may be treated as ambiguous and omitted from the training data set. Additional details regarding the determination of training data for a domain are discussed with respect to the method 800 shown in FIG. 8.

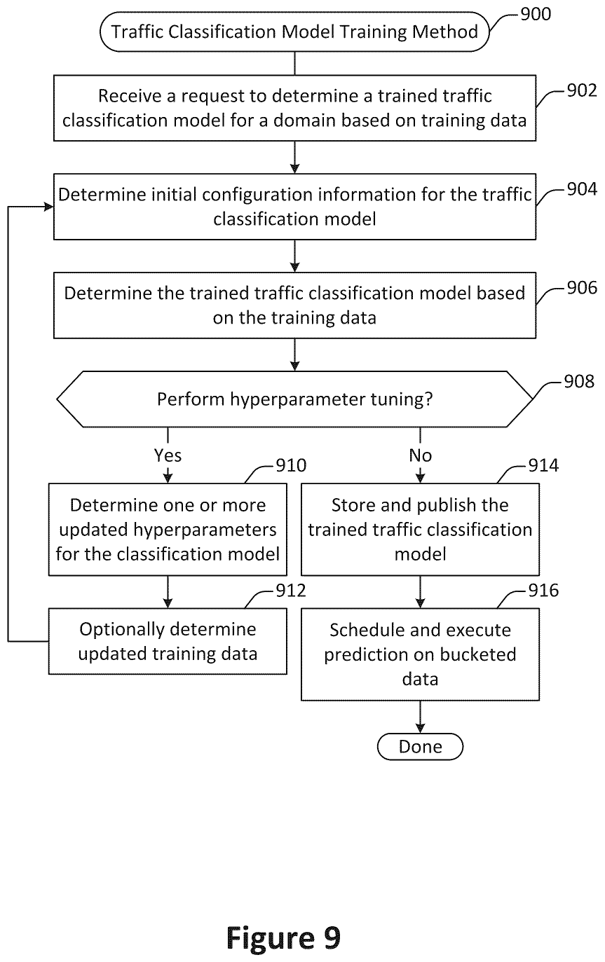

A trained classification model to classify application-layer request messages sent to the domain is determined at 106. According to various embodiments, any of a variety of classification models may be used, such as a random forest, a support vector machine, or another type of model. Additional details regarding the training of such a model are discussed with respect to the method 900 shown in FIG. 9.

One or more application-layer request messages sent to the domain are identified as malicious at 108. In some embodiments, the one or more application-layer request messages may be identified as malicious as part of a periodic scheduled prediction process in which bucketed requests are periodically analyzed.

A set of fingerprints to filter is determined at 110 based on the one or more application-layer request messages classified as malicious. Fingerprints identified in this way are then evaluated and sent to the application gateways for use in filtering.

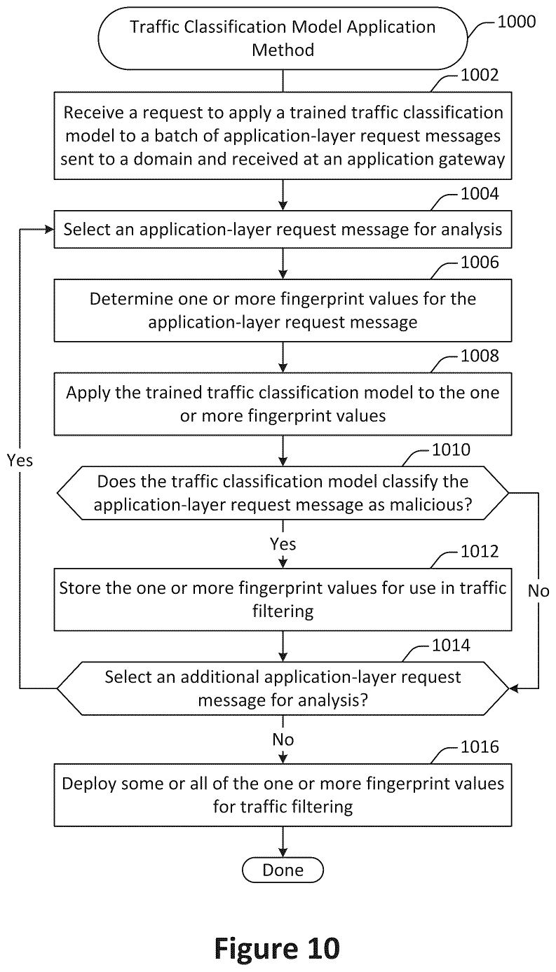

One or more application-layer request messages sent to the domain are identified as malicious based on the trained model at 108. The messages identified as malicious are then filtered at 110. Additional details regarding the application of a classification model to filter application-level request messages are discussed with respect to the method 1000 shown in FIG. 10.

### Network Traffic Classification and Filtering Systems

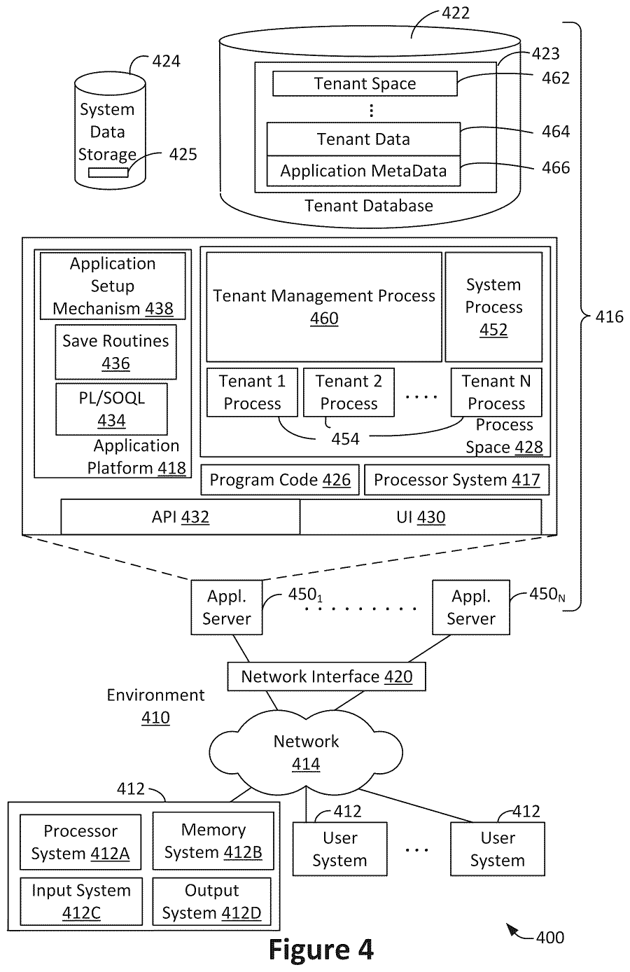

FIG. 2 illustrates a computing system 200, configured in accordance with one or more embodiments. The computing system 200 includes various elements that may be used to process traffic directed to a computing services environment, which may also be referred to herein as an on-demand database system. Additional components and processes associated with a computing services environment and/or an on-demand database system are discussed throughout the application, for instance with respect to FIG. 4 through FIG. 6.

The computing system 200 includes one or more application gateways, including the application gateway 202 through the application gateway 222. The computing system 200 also includes a fingerprint engine control plane 240, a message bus 250, a global fingerprint database 246, and a unified control plane 260. The application gateway 202 receives traffic at an external communication interface 206. The traffic is then passed to a web server integration engine 208, and then to a fingerprint traffic filter 210, and then to a policy-based traffic filter 212, and then to an internal communication interface 214. The fingerprint traffic filter 210 may retrieve fingerprints from a local fingerprint database 204. Similarly, the application gateway 222 receives traffic at an external communication interface 226. The traffic is then passed to a web server integration engine 228, and then to a fingerprint traffic filter 230, and then to a policy-based traffic filter 232, and then to an internal communication interface 234. The fingerprint traffic filter 230 may retrieve fingerprints from a local fingerprint database 224. The fingerprint engine control plane 240 includes a fingerprint receiver 242 and a fingerprint updater 244. Fingerprint control and management may be provided by the local control plane 216 and the local control plane 236.

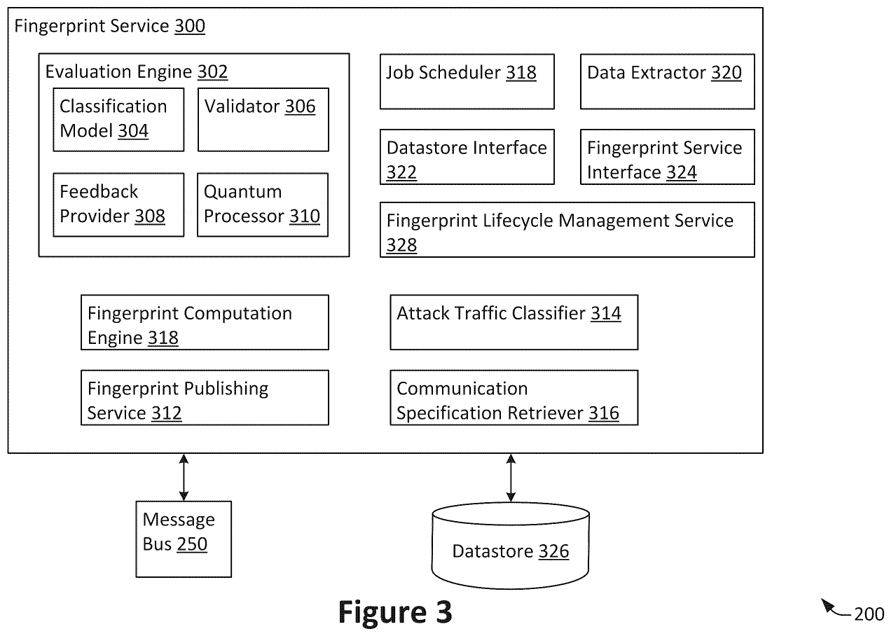

The computing system 200 also includes a fingerprint service 300. According to various embodiments, the fingerprint service 300 may be tasked with performing operations such as onboarding a domain and/or periodically or continually updating blocked fingerprints for a domain. Additional details regarding the fingerprint service 300 are discussed with respect to FIG. 3.

According to various embodiments, an application gateway 202 may receive requests via the Internet for computing operations to be performed by one or more components of a computing services environment. The requests may be received at the external communication interface 206. The application gateway 202 may be associated with a computing pod that includes a set of resources for providing the computing services. A computing services environment may include many such computing pods.

In some embodiments, the computing devices within a computing pod may be under the direct control of a service provider of the computing services environment. Alternatively, or additionally, one or more computing devices within a computing pod may be used by the service provider but directly controlled by a different entity. For instance, entities such as Amazon Web Services and Google Compute provide various computing devices and services that may be used by the service provider to provide the services of the computing services environment.

In some embodiments, the web server integration engine 208 may be used to perform one or more operations for processing requests received at the 206. For example, the web server integration engine 208 may run one or more predetermined scripts for processing incoming application requests.

In some embodiments, the fingerprint traffic filter 210 may determine one or more fingerprints for an incoming request. For example, the fingerprint traffic filter 210 may determine a locality-based fingerprint based on a hash function. The locality-based hash function may be used to measure an extent to which the request is highly similar to other requests received by the computing services environment. As another example, the fingerprint traffic filter 210 may determine an entropy-based fingerprint based on another hash function. The entropy-based hash function may be used to measure an extent to which the request is highly dissimilar to other requests received by the computing services environment. As yet another example, multiple fingerprints may be determined and potentially combined in any of various ways, as discussed in additional detail later in the application.

According to various embodiments, the fingerprint traffic filter 210 may perform operations such as intercepting the relevant data traffic, applying the fingerprint matching or verification logic, and/or taking appropriate actions based on the results of the fingerprint check. Examples of appropriate actions include, but are not limited to: allowing or blocking traffic, triggering alerts, logging events. Additional details regarding the determination of fingerprints are discussed throughout the application, for instance with respect to FIG. 9.

In some embodiments, a machine learning model may be applied to determine whether to block a request. For example, the machine learning model trained as discussed with respect to the method 900 shown in FIG. 9 may be deployed to the application gateway and run on fingerprints generated based on the request. The output of the application of the machine learning model may then be used to determine whether to classify the request as suspicious vs. suspicious and hence to block it.

In some embodiments, a probabilistic match may be employed to determine whether to block a request. For instance, a probabilistic process may yield a confidence score that a fingerprint for a newly received request matches a fingerprint from the database. Then, a request associated with a fingerprint that exceeds a predetermined confidence threshold may be blocked. In some configurations, the predetermined confidence threshold may be adjusted, for instance by lowering the threshold during active volumetric DDoS mitigation.

Information associated with requests received at the application gateway 202 may be sent to the message bus 250. Such information may include the requests themselves, metadata characterizing the requests, fingerprints determined based on the requests, and/or any other suitable information.

In some embodiments, information sent to the message bus 250 may be transmitted to the fingerprint engine control plane 240. The information may then be retrieved by the fingerprint receiver 242 within the fingerprint engine control plane 240. The fingerprint updater 244 may update the global fingerprint database 246. The global fingerprint database 246 may then be used to update the local fingerprint database 204 at the application gateway. In some implementations, either the local fingerprint database 204 or the global fingerprint database 246 may be omitted.

In some embodiments, the global fingerprint database 246 may be implemented as a centralized Redis datastore or other type of datastore. Configuration parameters such as update frequency may be strategically determined based on system characteristics.

According to various embodiments, updating the global fingerprint database 246 may involve operations associated with storing fingerprints to the global fingerprint database 246, removing fingerprints from the global fingerprint database 246, and/or updating information related to the global fingerprint database 246.

In some embodiments, the global fingerprint database 246 may be used to maintain a list of high-priority fingerprints to filter. High-priority fingerprints may be designated as such based on characteristics such as recency and frequency. For example, a fingerprint associated with relatively many recently-received requests may be designated as higher priority than a fingerprint associated with relatively fewer requests received further in the past.

In some embodiments, the number of fingerprints used to perform fingerprint-based traffic filtering at any given time may have performance implications, depending on the implementation. For instance, filtering based on a larger number of fingerprints may eliminate more malicious traffic at the expense of increased data storage and/or other computing resource utilization. Thus, the specific number of fingerprints to employ may be strategically determined based on system considerations.

According to various embodiments, traffic that passes the fingerprint traffic filter 210 may then be optionally processed by the policy-based traffic filter 212, which may be implemented at least in part via a web-application firewall (WAF). The unified control plane 260 may be used to determine one or more mitigation policies for implementation by the policy-based traffic filter 212. Such policy-based traffic filtering may be performed in addition to, or instead of, fingerprint-based traffic filtering. Examples of policy-based traffic filtering may include, but are not limited to, volumetric-based traffic filtering and/or autonomous AI agent-based traffic filtering. In volumetric approaches, traffic that exceeds a designated threshold may trigger the determination and imposition of mitigation plans that systematically block traffic meeting one or more criteria, such as traffic from one or more designated IP addresses. In autonomous AI agent-based responses, an autonomous AI agent may perform operations such as determining, validating, and/or revising a mitigation plan.

In some embodiments, policy-based traffic filtering may be selectively enabled when one or more triggering conditions are met. For example, policy-based traffic filtering may be employed when requests exceed a designated threshold. As another example, policy-based traffic filtering may be employed when an autonomous AI agent determines that a distributed denial of service attack is occurring. Additional details regarding other security techniques that may be employed in conjunction with techniques and mechanisms described herein are discussed in U.S. patent application Ser. No. 19/096,380, filed Mar. 31, 2025 by Mainardi et al., titled “Autonomous Agent Generation, Review, And Correction of Mitigation Plans Against DDoS Attacks In a Shared Infrastructure Computing Environment”, which is incorporated herein by reference in its entirety and for all purposes.

Traffic that is not blocked via one or more filters may be processed by the internal communication interface 214. The internal communication interface 214 may be tasked with forwarding the request to one or more other components within the computing services environment. For instance, the request may be forwarded to an application server tasked with handling the request.

In some embodiments, the elements 206 through 214 collectively constitute a data path for processing requests. One or more of such elements may be implemented in a containerized fashion, for instance within a Kubernetes pod using a sidecar model for HTTP request forwarding. The fingerprint database 204 may be implemented as a Redis cache.

In some embodiments, the local control plane 216 may perform various operations related to fingerprint processing and filtering. For example, the local control plane 216 may perform operations such as configuration and policy management for fingerprint-based enforcement, real-time monitoring and reporting of fingerprint-related activity, local override or exception handling for specific scenarios, integration with other local security controls or management systems, and/or interfaces for administration and troubleshooting.

FIG. 3 illustrates additional elements of the computing system 200, configured in accordance with one or more embodiments. The computing services environment 200 includes the message bus 250, a fingerprint service 300, and a datastore 326.

According to various embodiments, the fingerprint service 300 may be tasked with performing operations such as onboarding a domain and/or periodically or continually updating blocked fingerprints for a domain. The fingerprint service 300 includes an evaluation engine 302, which includes a machine learning model 304, a validator 306, a feedback provider 308, and a quantum processor 310. The fingerprint service 300 also includes a job scheduler 318, a data extractor 320, a datastore interface 322, a fingerprint service interface 324, a fingerprint computation engine 318, a fingerprint publishing service 312, an attack traffic classifier 314, a communication specification retriever 316, and a fingerprint lifecycle management service 328.

According to various embodiments, the fingerprint service interface 324 provides a communication interface for receiving a request to add a new domain to the system and for managing data and metadata associated with domains included in the system. Such management may include specification of various parameters influencing the system's behavior.

In some embodiments, the fingerprint service interface 324 may allow a systems administrator to configure how, when, and which data is queried for the purpose of determining fingerprints. Such configuration may facilitate customized log analysis and threat detection.

In some embodiments, the fingerprint service interface 324 may allow a systems administrator to fine-tune the behavior of various detection and mitigation algorithms by adjusting specific parameters. Further, the fingerprint service interface 324 may provide the ability to enable or disable specific features for each domain, offering granular control over the system's functionality.

According to various embodiments, data and metadata associated with the operation of the 300 may be stored in the datastore 326 via the datastore interface 322. For example, the datastore 326 may store configuration information and other domain-specific information for one or more domains included in the system. As another example, the datastore 326 may store fingerprints used to distinguish between legitimate and malicious traffic patterns.

According to various embodiments, the job scheduler 318 facilitates scheduling jobs for onboarded domains. A job may have a predefined work plan that generates a new set of fingerprints for the associated domain. The generated fingerprints can then be stored, for instance in the datastore 326.

In some embodiments, the communication retriever 316 provides enhanced security and efficiency of web applications by continuously monitoring and updating communication specifications from a variety of sources. For instance, the communication specification retriever 316 may monitor sources such as public documentation and version control systems (e.g., Git repositories) to identify communication interfaces for communicating with the one or more domains. The retrieved communication specification information may then be used to identify traffic that does not comply with the communication specification. By fetching and analyzing these communication specifications, the Fetcher can intelligently generate a set of URLs that are specifically designed to differentiate between legitimate and malicious traffic.

According to various embodiments, the data extractor 320 is configured to retrieve specific data to determine fingerprints for the received request. For instance, data may be retrieved from server logs via a Splunk integration and query system via one or more pre-defined queries. The data extractor 320 provides for a flexible and adaptable approach in which queries can be easily modified to include or exclude specific data points as the feature set considered for fingerprint determination changes.

According to various embodiments, the attack traffic classifier 314 combines communication specification information retrieved via the communication specification retriever 316 with traffic data retrieved via the data extractor 320 to determine a dataset for use in fingerprint determination. For instance, the attack traffic classifier 314 may retrieve traffic that does not comply with a communication specification for a domain and then create a dataset that identifies such traffic along with the data fields needed to determine fingerprints for the traffic.

In some embodiments, some or all of the retrieved data may be cleaned. Data cleaning may involve operations such as filtering out irrelevant data, correcting errors, or transforming the data into a suitable format for fingerprint generation, and/or other such procedures.

According to various embodiments, the fingerprint computation engine 318 may generate one or more fingerprints for traffic classification. Fingerprints may be computed based on recency to focus on attack traffic more likely to be observed again soon. For instance, in some configurations the system may compute fingerprints for the smaller of either the last 24 hours of traffic or the most recent 10 million records. However, the specific parameter values used to configure the determination of fingerprints may be strategically determined based on characteristics such as system performance.

In some embodiments, onboarding a new domain may involve configuring a temporary (e.g., 4-week) evaluation period to assess the effectiveness of fingerprint matching. The self-evaluation process may involve generating a model based on the data generated during the evaluation period and validating it against the most recent data (e.g., 24 hours or 10 million records). The domain may be treated as successfully onboarded if the efficacy exceeds a designated threshold (e.g., 90%).

In some embodiments, following successful onboarding and validation, the system may update the fingerprint database periodically, for instance approximately every 10 minutes. The fingerprint database may then be maintained as a rolling window (e.g., the past 4 hours, 1 day, 2 days, etc.). In this way, the system can adapt to changes in traffic patterns and ensure the fingerprints remain relevant.

In some embodiments, as discussed herein, the fingerprint-based system may be recalibrated upon detecting a volumetric DDoS attack. For example, one or more configuration parameters may be adjusted. As another example, the fingerprint-based approach may be halted completely and temporarily replaced with volumetric restrictions.

The fingerprint publishing service 312 facilitates dissemination of the fingerprints to the relevant control plane(s). According to various embodiments, such distribution s allows for the fingerprints to be added into the data path of incoming requests, enabling efficient identification and mitigation of potential threats. Given that the control plane may be situated in diverse geographical locations across the globe, the fingerprint publishing service 312 can be configured to provide eventual consistency with high durability guarantees. Such an approach ensures that data is replicated and synchronized across all locations overtime, while also maintaining data persistence and integrity. From a Consistency, Availability, Partition Tolerance (CAP) theorem perspective, this approach prioritizes Availability over Consistency, recognizing the importance of system accessibility and responsiveness, even if it may result in temporary inconsistencies in data across different locations.

In some embodiments, the fingerprint publishing service 312 may expose APIs (e.g., REST/gRPC) on the control plane, allowing the publishing engine to invoke these APIs with retry mechanisms in case of failures. Such an approach provides a direct and programmatic way to interact with the control plane and publish the fingerprint database.

In some embodiments, a message bus can be leveraged to implement a publish/subscribe model, where the publishing engine publishes the fingerprint database to a topic, and the control plane subscribes to that topic to receive updates. Such an approach decouples the publishing service from the control plane and allows for asynchronous communication.

According to various embodiments, the fingerprint lifecycle management service 328 may oversee the lifecycle of a fingerprint, from initial generation to eventual expiration and revocation. For example, the fingerprint lifecycle management service 328 may perform operations such as: (1) triggering the fingerprint generation process based on predefined criteria or events; (2) storing and managing the generated fingerprints in a secure and accessible manner; (3) triggering the publication of the fingerprints to the relevant enforcement points or systems; (4) monitoring the usage and effectiveness of the fingerprints; (5) handling updates or replacements of fingerprints as needed; (6) ensuring proper expiration or revocation of fingerprints based on policy or time-based rules; and/or other such operations.

According to various embodiments, the evaluation engine 302 may be configured to perform various operations related to determining, training, and validating a machine learning model. The evaluation engine 302 includes a classification model 304, which may be trained to distinguish between suspicious traffic and legitimate traffic. The classification model 304 may then be deployed for application at one or more application gateways to assist in filtering traffic.

In some embodiments, the classification model 304 may be trained in a domain-specific manner. Alternatively, the classification model 304 may be trained to cover multiple domains. For instance, the classification model 304 may be trained to filter traffic from a set of domains associated with a particular computing pod or other portion of a computing services environment.

According to various embodiments, any of a variety of classification models may be used. Examples of suitable classification models include, but are not limited to: support vector machines, random forest models, naïve Bayes models, decision trees, K-Nearest neighbors, gradient boosting, neural networks, other types of models, and ensemble models.

In some embodiments, the validator 306 may evaluate the performance of the trained classification model. Validation may occur when a new domain is onboarded and/or on a periodic or continual basis. For example, when a new domain is onboarded, the system may undergo an evaluation period (e.g., a 4-week period) to assess the effectiveness of the model's signature matching. This self-evaluation process may involve generating a model based on the data collected during the period and then validating it against the most recent records. The most recent records may be collected from a period of time (e.g., the last 24 hours) or a designated number of records (e.g., 10 million records). If the efficacy of the model exceeds a specified threshold (e.g., 90%), then domain may be considered successfully onboarded.

In some embodiments, the feedback provider 308 may receive and process feedback directed to the evaluation engine 302. For example, the feedback provider 308 may store information characterizing model performance over time. As another example, feedback provider 308 may collect and store information about whether requests classified as legitimate turned out to be malicious.

According to various embodiments, the quantum processor 310 may be located either inside or outside of the computing environment 200. For example, the quantum processor 310 may be a processor from D-Wave, IonQ, Rigetti, or another such company accessed via the Amazon Bracket service from Amazon Web Services or Quantum AI from Google.

### Computing Services Environment Architecture and Operation

FIG. 4 shows a block diagram of an example of an environment 410 that includes an on-demand database service configured in accordance with some implementations. Environment 410 may include user systems 412, network 414, database system 416, processor system 417, application platform 418, network interface 420, tenant data storage 422, tenant data 423, system data storage 424, system data 425, program code 426, process space 428, User Interface (UI) 430, Application Program Interface (API) 432, PL/SOQL 434, save routines 436, application setup mechanism 438, application servers 450-1 through 450-N, system process space 452, tenant process spaces 454, tenant management process space 460, tenant storage space 462, user storage 464, and application metadata 466. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 416, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 418 may be a framework that allows the creation, management, and execution of applications in system 416. Such applications may be developed by the database service provider or by users or third-party application developers accessing the service. Application platform 418 includes an application setup mechanism 438 that supports application developers' creation and management of applications, which may be saved as metadata into tenant data storage 422 by save routines 436 for execution by subscribers as one or more tenant process spaces 454 managed by tenant management process 460 for example. Invocations to such applications may be coded using PL/SOQL 434 that provides a programming language style interface extension to API 432. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on June, 2010, and hereby incorporated by reference in its entirety and for all purposes. Invocations to applications may be detected by one or more system processes. Such system processes may manage retrieval of application metadata 466 for a subscriber making such an invocation. Such system processes may also manage execution of application metadata 466 as an application in a virtual machine.

In some implementations, each application server 450 may handle requests for any user associated with any organization. A load balancing function (e.g., an F5 Big-IP load balancer) may distribute requests to the application servers 450 based on an algorithm such as least-connections, round robin, observed response time, etc. Each application server 450 may be configured to communicate with tenant data storage 422 and the tenant data 423 therein, and system data storage 424 and the system data 425 therein to serve requests of user systems 412. The tenant data 423 may be divided into individual tenant storage spaces 462, which can be either a physical arrangement and/or a logical arrangement of data. Within each tenant storage space 462, user storage 464 and application metadata 466 may be similarly allocated for each user. For example, a copy of a user's most recently used (MRU) items might be stored to user storage 464. Similarly, a copy of MRU items for an entire tenant organization may be stored to tenant storage space 462. A UI 430 provides a user interface and an API 432 provides an application programming interface to system 416 resident processes to users and/or developers at user systems 412.

System 416 may implement a web-based attack detection and mitigation system. For example, in some implementations, system 416 may include application servers configured to implement and execute software applications for detecting and mitigating distributed denial of service attacks. The application servers may be configured to provide related data, code, forms, web pages and other information to and from user systems 412. Additionally, the application servers may be configured to store information to, and retrieve information from a database system. Such information may include related data, objects, and/or Webpage content. With a multi-tenant system, data for multiple tenants may be stored in the same physical database object in tenant data storage 422, however, tenant data may be arranged in the storage medium(s) of tenant data storage 422 so that data of one tenant is kept logically separate from that of other tenants. In such a scheme, one tenant may not access another tenant's data, unless such data is expressly shared.

Several elements in the system shown in FIG. 4 include conventional, well-known elements that are explained only briefly here. For example, user system 412 may include processor system 412A, memory system 412B, input system 412C, and output system 412D. A user system 412 may be implemented as any computing device(s) or other data processing apparatus such as a mobile phone, laptop computer, tablet, desktop computer, or network of computing devices. User system 2 may run an internet browser allowing a user (e.g., a subscriber of an MTS) of user system 412 to access, process and view information, pages and applications available from system 416 over network 414. Network 414 may be any network or combination of networks of devices that communicate with one another, such as any one or any combination of a LAN (local area network), WAN (wide area network), wireless network, or other appropriate configuration.

The users of user systems 412 may differ in their respective capacities, and the capacity of a particular user system 412 to access information may be determined at least in part by “permissions” of the particular user system 412. As discussed herein, permissions generally govern access to computing resources such as data objects, components, and other entities of a computing system, such as a social networking system, and/or a CRM database system. “Permission sets” generally refer to groups of permissions that may be assigned to users of such a computing environment. For instance, the assignments of users and permission sets may be stored in one or more databases of System 416. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 416 may provide on-demand database service to user systems 412 using an MTS arrangement. By way of example, one tenant organization may be a company that employs a sales force where each salesperson uses system 416 to manage their sales process. Thus, a user in such an organization may maintain contact data, leads data, customer follow-up data, performance data, goals and progress data, etc., all applicable to that user's personal sales process (e.g., in tenant data storage 422). In this arrangement, a user may manage his or her sales efforts and cycles from a variety of devices, since relevant data and applications to interact with (e.g., access, view, modify, report, transmit, calculate, etc.) such data may be maintained and accessed by any user system 412 having network access.

When implemented in an MTS arrangement, system 416 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 416 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 416 may also maintain system-level data usable by multiple tenants or other data. Such system-level data may include industry reports, news, postings, and the like that are sharable between tenant organizations.

In some implementations, user systems 412 may be client systems communicating with application servers 450 to request and update system-level and tenant-level data from system 416. By way of example, user systems 412 may send one or more queries requesting data of a database maintained in tenant data storage 422 and/or system data storage 424. An application server 450 of system 416 may automatically generate one or more SQL statements (e.g., one or more SQL queries) that are designed to access the requested data. System data storage 424 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 7, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

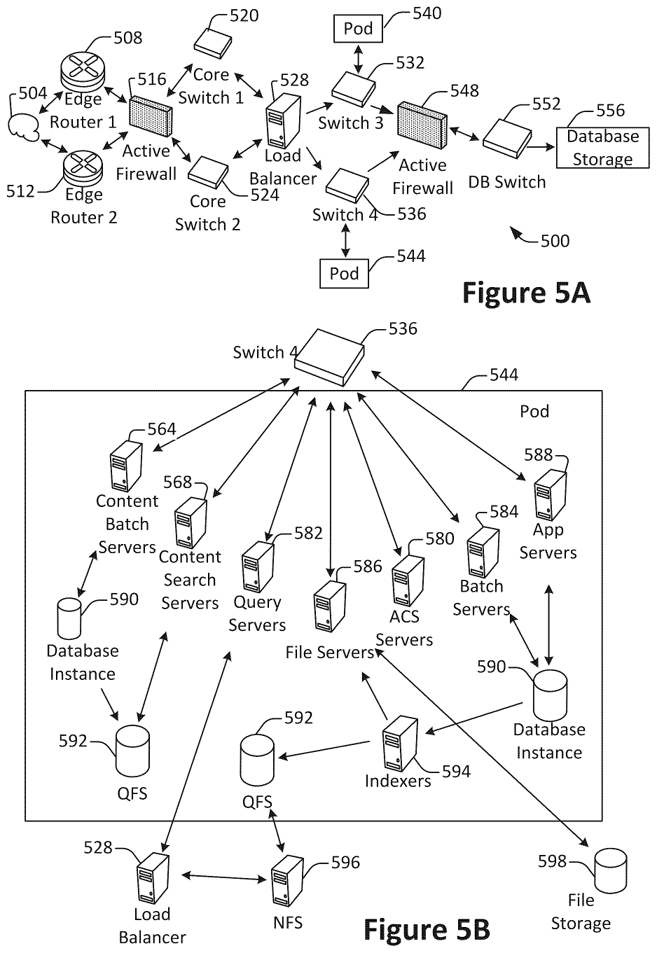

FIG. 5A shows a system diagram of an example of architectural components of an on-demand database service environment 500, configured in accordance with some implementations. A client machine located in the cloud 504 may communicate with the on-demand database service environment via one or more edge routers 508 and 512. A client machine may include any of the examples of user systems 412 described above. The edge routers 508 and 512 may communicate with one or more core switches 520 and 524 via firewall 516. The core switches may communicate with a load balancer 528, which may distribute server load over different pods, such as the pods 540 and 544 by communication via pod switches 532 and 536. The pods 540 and 544, which may each include one or more servers and/or other computing resources, may perform data processing and other operations used to provide on-demand services. Components of the environment may communicate with a database storage 556 via a database firewall 548 and a database switch 552.

Accessing an on-demand database service environment may involve communications transmitted among a variety of different components. The environment 500 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 5A and 5B.

The cloud 504 refers to any suitable data network or combination of data networks, which may include the Internet. Client machines located in the cloud 504 may communicate with the on-demand database service environment 500 to access services provided by the on-demand database service environment 500. By way of example, client machines may access the on-demand database service environment 500 to retrieve, store, edit, and/or process distributed denial of service attack and mitigation information.

In some implementations, the edge routers 508 and 512 route packets between the cloud 504 and other components of the on-demand database service environment 500. The edge routers 508 and 512 may employ the Border Gateway Protocol (BGP). The edge routers 508 and 512 may maintain a table of IP networks or ‘prefixes’, which designate network reachability among autonomous systems on the internet.

In one or more implementations, the firewall 516 may protect the inner components of the environment 500 from internet traffic. The firewall 516 may block, permit, or deny access to the inner components of the on-demand database service environment 500 based upon a set of rules and/or other criteria. The firewall 516 may act as one or more of a packet filter, an application gateway, a stateful filter, a proxy server, or any other type of firewall.

In some implementations, the core switches 520 and 524 may be high-capacity switches that transfer packets within the environment 500. The core switches 520 and 524 may be configured as network bridges that quickly route data between different components within the on-demand database service environment. The use of two or more core switches 520 and 524 may provide redundancy and/or reduced latency.

In some implementations, communication between the pods 540 and 544 may be conducted via the pod switches 532 and 536. The pod switches 532 and 536 may facilitate communication between the pods 540 and 544 and client machines, for example via core switches 520 and 524. Also or alternatively, the pod switches 532 and 536 may facilitate communication between the pods 540 and 544 and the database storage 556. The load balancer 528 may distribute workload between the pods, which may assist in improving the use of resources, increasing throughput, reducing response times, and/or reducing overhead. The load balancer 528 may include multilayer switches to analyze and forward traffic.

In some implementations, access to the database storage 556 may be guarded by a database firewall 548, which may act as a computer application firewall operating at the database application layer of a protocol stack. The database firewall 548 may protect the database storage 556 from application attacks such as structure query language (SQL) injection, database rootkits, and unauthorized information disclosure. The database firewall 548 may include a host using one or more forms of reverse proxy services to proxy traffic before passing it to a gateway router and/or may inspect the contents of database traffic and block certain content or database requests. The database firewall 548 may work on the SQL application level atop the TCP/IP stack, managing applications' connection to the database or SQL management interfaces as well as intercepting and enforcing packets traveling to or from a database network or application interface.

In some implementations, the database storage 556 may be an on-demand database system shared by many different organizations. The on-demand database service may employ a single-tenant approach, a multi-tenant approach, a virtualized approach, or any other type of database approach. Communication with the database storage 556 may be conducted via the database switch 552. The database storage 556 may include various software components for handling database queries. Accordingly, the database switch 552 may direct database queries transmitted by other components of the environment (e.g., the pods 540 and 544) to the correct components within the database storage 556.

FIG. 5B shows a system diagram further illustrating an example of architectural components of an on-demand database service environment, in accordance with some implementations. The pod 544 may be used to render services to user(s) of the on-demand database service environment 500. The pod 544 may include one or more content batch servers 564, content search servers 568, query servers 582, file servers 586, access control system (ACS) servers 580, batch servers 584, and app servers 588. Also, the pod 544 may include database instances 590, quick file systems (QFS) 592, and indexers 594. Some or all communication between the servers in the pod 544 may be transmitted via the switch 536.

In some implementations, the app servers 588 may include a framework dedicated to the execution of procedures (e.g., programs, routines, scripts) for supporting the construction of applications provided by the on-demand database service environment 500 via the pod 544. One or more instances of the app server 588 may be configured to execute all or a portion of the operations of the services described herein.

In some implementations, as discussed above, the pod 544 may include one or more database instances 590. A database instance 590 may be configured as an MTS in which different organizations share access to the same database, using the techniques described above. Database information may be transmitted to the indexer 594, which may provide an index of information available in the database 590 to file servers 586. The QFS 592 or other suitable filesystem may serve as a rapid-access file system for storing and accessing information available within the pod 544. The QFS 592 may support volume management capabilities, allowing many disks to be grouped together into a file system. The QFS 592 may communicate with the database instances 590, content search servers 568 and/or indexers 594 to identify, retrieve, move, and/or update data stored in the network file systems (NFS) 596 and/or other storage systems.

In some implementations, one or more query servers 582 may communicate with the NFS 596 to retrieve and/or update information stored outside of the pod 544. The NFS 596 may allow servers located in the pod 544 to access information over a network in a manner similar to how local storage is accessed. Queries from the query servers 522 may be transmitted to the NFS 596 via the load balancer 528, which may distribute resource requests over various resources available in the on-demand database service environment 500. The NFS 596 may also communicate with the QFS 592 to update the information stored on the NFS 596 and/or to provide information to the QFS 592 for use by servers located within the pod 544.

In some implementations, the content batch servers 564 may handle requests internal to the pod 544. These requests may be long-running and/or not tied to a particular customer, such as requests related to log mining, cleanup work, and maintenance tasks. The content search servers 568 may provide query and indexer functions such as functions allowing users to search through content stored in the on-demand database service environment 500. The file servers 586 may manage requests for information stored in the file storage 598, which may store information such as documents, images, basic large objects (BLOBs), etc. The query servers 582 may be used to retrieve information from one or more file systems. For example, the query system 582 may receive requests for information from the app servers 588 and then transmit information queries to the NFS 596 located outside the pod 544. The ACS servers 580 may control access to data, hardware resources, or software resources called upon to render services provided by the pod 544. The batch servers 584 may process batch jobs, which are used to run tasks at specified times. Thus, the batch servers 584 may transmit instructions to other servers, such as the app servers 588, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

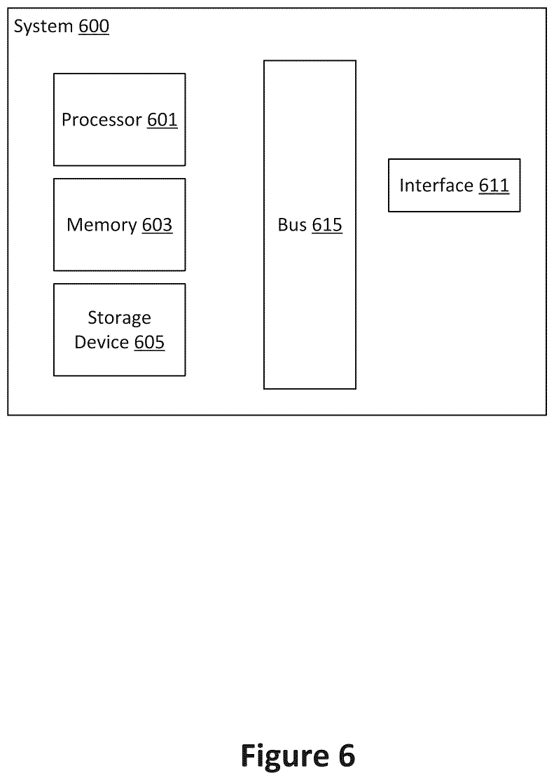

FIG. 6 illustrates one example of a computing device. According to various embodiments, a system 600 suitable for implementing embodiments described herein includes a processor 601, a memory module 603, a storage device 605, an interface 611, and a bus 615 (e.g., a PCI bus or other interconnection fabric.) System 600 may operate as variety of devices such as an application server, a database server, or any other device or service described herein. Although a particular configuration is described, a variety of alternative configurations are possible. The processor 601 may perform operations such as those described herein. Instructions for performing such operations may be embodied in the memory 603, on one or more non-transitory computer readable media, or on some other storage device. Various specially configured devices can also be used in place of or in addition to the processor 601. The interface 611 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In various implementations, the models and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s). Additional discussion of AI technology that may be used in conjunction with techniques and mechanisms described herein is described in U.S. patent application Ser. No. 19/037,321, filed Jan. 27, 2025 by Kshirsagar et al., titled Artificial Intelligence Agent Architecture in a Database System, which is incorporated herein by reference in its entirety and for all purposes.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

### Techniques for Fingerprint Generation and Traffic Filtering

FIG. 7 illustrates a domain onboarding and fingerprint generation method 700, performed in accordance with one or more embodiments. The method 700 may be performed at the computing system 200 shown in FIG. 2 and FIG. 3, and/or within other components of the computing services environment.

A request is received at 708 to onboard a new domain. In some embodiments, the request may be generated when a new domain is added to the computing services environment. Alternatively, an existing domain within the computing services environment may be identified for fingerprint-based protection.

In some embodiments, a new domain may be onboarded based on user input, for instance from a systems administrator. Alternatively, or additionally, a new domain may be onboarded when a triggering condition is met, such as when a sufficiently large volume of attack traffic is identified.

Metadata associated with the new domain is identified at 710 and stored in the datastore 326. In some embodiments, the metadata may include information such as one or more communication specifications for communicating with the domain. The metadata may also include other information, such as one or more configuration settings for the domain.

The onboarding of a new domain may trigger the generation of a job in the job scheduler 318. The job scheduler 318 may also store jobs associated with periodic updates of fingerprint information for existing domains. The job scheduler 318 may retrieve information characterizing jobs from the datastore 326.

A determination is made at 712 as to whether a job is associated with a new domain being onboarded. Upon determining that a job is associated with a newly onboarded domain, recent attack traffic is extracted at 714 via the data extractor 320 for a period of time. For example, the attack traffic may be extracted for the maximum period of time for which fingerprints are stored before revocation. As another example, the attack traffic may be extracted up to a maximum predetermined number of records.

Upon extracting the attack traffic, the fingerprints are generated at 716. In some embodiments, as discussed herein, the newly added domain then enters a validation period.

Upon determining instead that the job corresponds to an existing domain, unanalyzed attack traffic is extracted at 718. In some embodiments, the unanalyzed attack traffic may include attack traffic received during the period since the domain was most recently analyzed. Alternatively, or additionally, the unanalyzed attack traffic may be collected for a period of time, such as the last 10 minutes. In the event that the volume of unanalyzed attack traffic exceeds a maximum threshold for analysis, the unanalyzed attack traffic may be, for instance, randomly sampled.

Fingerprints for the unanalyzed attack traffic are then generated at 720 and used to generate an updated fingerprint set. The new fingerprints may span a period of time (e.g., one or more hours or days) and/or a number of requests (e.g., up to a maximum request limit).

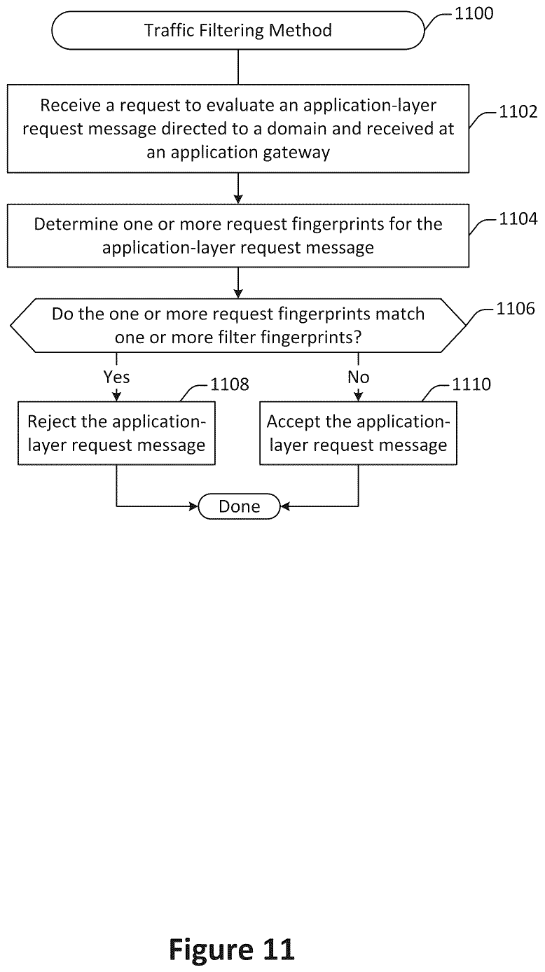

According to various embodiments, the unanalyzed traffic may be used to generate a new fingerprint set for use in filtering. For instance, as discussed in additional detail with respect to FIG. 8, traffic data may be used to generate training data for training a machine learning model. Then, as discussed with respect to FIG. 9, the training data may be used to train a machine learning model. As discussed with respect to FIG. 10, the machine learning model may be applied to traffic data to determine a set of fingerprints to filter. The filtering may then be applied as discussed with respect to the method 1100 shown in FIG. 11.

At 722, an indication that new fingerprints are available is sent to the fingerprint publish service 312. At 724, one or more fingerprints are retrieved from the global database and published at 726 to one or more local databases by the fingerprint publish service 312. Fingerprints may also be stored to the datastore 326. The fingerprints sent to the fingerprint publish service 312 may include those determined directly from the analyzed traffic and/or those determined based on application of a machine learning model trained on such data.

The flowchart 700 shown in FIG. 7 includes various elements divided into different portions, including a domain onboarding portion 702, a fingerprint generation portion 704, and a fingerprint publishing portion 706. In some situations, the operations shown in these different portions may be performed as part of the same process flow. However, these operations may also be performed separately. For example, fingerprint generation 704 may be performed for existing domains, in which case operations

FIG. 8 illustrates a method 800 of determining fingerprint training data for traffic filtering, performed in accordance with one or more embodiments. The method 800 may be performed at the computing system 200 shown in FIG. 2.

A request to determine traffic fingerprint training data for a domain is received at 802. In some embodiments, the request may be generated as discussed with respect to the operations 718 and/or 714 shown in FIG. 7. The request may be generated periodically, such as once per hour. Alternatively, the request may be generated upon detection of a triggering condition, such as the onboarding of a new domain, the receipt of a threshold level of traffic, and/or the receipt of a designated volume of traffic.

An application-layer request message directed to the domain is identified for analysis at 804. In some embodiments, the request may be received at an application gateway such as those shown in FIG. 2.

A communication specification for the application-layer request message is identified at 806. The communication specification may include, for instance, one or more elements of an application procedure interface (API) for transmitting requests to the domain. The communication may specify, for example, one or more addresses to which to send traffic, one or more ports to which to send traffic, one or more content elements to include in a request message, and/or other rules for formulating and/or transmitting the requests.

In some configurations, the communication specification may govern all application-level traffic associated with the domain. Alternatively, different types of traffic may be associated with different communication specifications. In such a configuration, the appropriate communication specification may be identified based on one or more characteristics of the request, such as an address to which the request is directed at the domain.

A determination is made at 808 as to whether the request complies with the communication specification. In some embodiments, the determination may be made as part of the normal processing of the such requests. Upon determining that the request does not comply with the communication specification, the request is labeled as malicious at 814 and added to the training data.

Upon determining instead that the request does comply with the communication specification, a determination is made at 810 as to whether the request succeeds. A request may succeed when it meets one or more criteria specified by the destination which the request is directed, such as an application server. For example, an authentication request may succeed if the authentication attempt results in successful authentication. As another example, an application request message may succeed if it is received in the context of an existing authentication communication session and is otherwise well-formed. The specific criteria used to determine authentication may depend on the context, but success may be determined based on a response message received from the recipient of the request within the computing system, such as an application server.

Upon determining that the request succeeds, the request is labeled as non-malicious and added to the training data at 812. Upon determining instead that the request does not succeed, the request may be treated as ambiguous and ignored.

At 816, a determination is made as to whether to identify an additional application-layer request message for analysis. In some embodiments, additional application-layer request messages may continue to be analyzed until all or a suitable number of the unprocessed application layer request messages have been analyzed.

Fingerprint values for the training data are determined at 818. A first set of fingerprint values is determined at 104 by evaluating traffic features associated with the first set of application-layer request messages. In some embodiments, a traffic feature may be associated with content included in a request. Alternatively, a traffic feature may be associated with other aspects of the request, such as an IP address from which the request was sent, a port to which the request was sent, or other such characteristics.

In some embodiments, a fingerprint may be determined based on a hash function. Depending on the configuration, one or more of a wide variety of hash functions may be used. Specific examples of fingerprints based on hash functions included both locality-based and entropy-based fingerprints. Examples of suitable fingerprints and techniques for their calculation are discussed throughout the application.

In some embodiments, fingerprints may be stored as part of a labeled and annotated data set, such as the following:

```
{ “id”: “DOMAIN_01”,
  “class_good”:[“fp1”, “fp2”, . . . ],
  “class_bad”: [“fp3”, “fp4”, . . .]}
```

According to various embodiments, one or more of the operations shown in FIG. 8 may be performed in a different order, and/or may be performed in parallel. In some embodiments, one or more fingerprint values may be determined via batched analysis. For instance, the one or more application-layer request messages may be received at one or more application gateways, and information related to the request messages may be stored for further analysis. The information may then later be retrieved and used to determine the training data.

According to various embodiments, the training data including the fingerprint values may be stored in a database system. The database system may be a central database system associated with the computing services environment as a whole. Alternatively, or additionally, fingerprint values may be stored in more localized database systems. For instance, different computing components, groups of computing components, geographic regions, and/or other divisions of the computing services environment may be associated with different fingerprint databases, for instance to capture variation in traffic received at the different divisions.

FIG. 9 illustrates a method 900 of determining a trained traffic classification model, performed in accordance with one or more embodiments. The method 900 may be performed at the computing system 200 shown in FIG. 2.

A request to determine a trained traffic classification model for a domain based on training data is received at 902. In some embodiments, the request may be generated at periodic times, such as once per hour. Alternatively, the request may be generated upon detection of a triggering condition, such as the onboarding of a new domain, the receipt of a threshold level of traffic, and/or the receipt of a designated volume of traffic.

Initial configuration for the traffic classification model is determined at 904. According to various embodiments, the specific type of initial configuration determined may depend on the type of classification model being trained. For example, configuration information for a random forest model may specify information such as the number of trees to include in the random forest, the number of training iterations to perform, one or more stopping conditions for the training process, a maximum depth of a tree, and/or other such data. However, different configuration may be determined for other types of classification models, such as a support vector machine.

In some embodiments, the initial configuration information may be predetermined, for instance retrieved from a configuration file. Alternatively, or additionally, some or all of the configuration information may be determined subject to hyperparameter tuning, in which various configuration parameters are tried in parallel or succession to improve the model's performance.

According to various embodiments, hyperparameters may include configuration parameters used to guide elements such as fingerprint generation, model initialization, model training, and the like. For example, fingerprint generation hyperparameters may include parameters governing which types of fingerprints are generated, how the generation of those fingerprints is configured, which traffic features are used to generate the fingerprints, how generated fingerprints are combined, and/or other such considerations. As another example, model initialization hyperparameters may include parameters governing which model or models are trained as well as model-specific parameters such as a number and/or depth of trees to include in a random forest model. As yet another example, model training hyperparameters may specify characteristics such as a number of training iterations, a number of training epochs, a division of data into training vs. test subsets, one or more stopping conditions for training, and the like.

According to various embodiments, the specific numbers and configurations of hyperparameters to train may be strategically determined based on system configuration and performance. Increasing the number and granularity of the hyperparameter space increases model performance at the expense of additional training time and other computing resources.

In some embodiments, multiple models may be trained for a single data set. Then, the various models may be weighted and used to determine an ensemble model. The initial configuration may be provided via an API call, for instance via calls such as the following:

```
{{ “id”: 01, “model”: {“type”: “RandomForest”, “params”: {“n_estimators”: 100},
“data”: “DOMAIN_01”}},
  {“id”: 02, “model”: { “type”: “GradientBoosting”, “params”: {“max_depth”: 3},
  “data”: “ DOMAIN_01”}}}
```

The trained traffic classification model is determined at 906 based on the training data. According to various embodiments, the traffic classification model may be trained in a manner suitable for the model type. Thus, the specific operations for training the traffic classification model may be determined based on the system configuration.

In some embodiments, determining the trained traffic classification model may involve determining weights for reaching a final decision as to whether a fingerprint is legitimate or suspicious. For instance, the two models in the examples provided above may be weighted 0.8/0.2, 0.5/0.5, or via another weighting scheme. The weighting scheme may be determined by evaluating the performance of various weighting schemes on the training data.

In particular embodiments, the trained classification model may include a quantum-classical support vector machine. Additional details regarding the training and application of a quantum-classical support vector machine are discussed throughout the application, for instance with respect to the method 1100 shown in FIG. 11.

A determination is made at 908 as to whether to perform hyperparameter tuning. In some embodiments, the determination may be made based at least in part on the model performance. For instance, one or more hyperparameters may be altered until a suitable level of model performance is obtained and/or when successive alterations do not yield significant improvements in model performance.

Upon determining to perform hyperparameter tuning, one or more updated hyperparameters for the classification model are determined at 910. According to various embodiments, any of a variety of types of model hyperparameters may be subject to tuning. For example, one or more model hyperparameters may relate to the traffic fingerprints, such as one or more parameters specifying the traffic features selected for fingerprinting, the types of fingerprints applied to the selected traffic features, one or more configuration parameters governing the types of fingerprints. As another example, one or more model hyperparameters may relate to the initial model configuration information determined at 904.

Updated training data is optionally determined at 912. In some embodiments, updated training data may be determined if the one or more model hyperparameters include elements of fingerprint determination. In such a situation, the updated training data may be determined by recomputing the fingerprint values for the traffic included in the training data, for instance as discussed with respect to the operation 818 shown in FIG. 8.

Upon determining instead not to perform hyperparameter tuning, the trained traffic classification model is stored and published at 914. Storing and publishing the trained traffic classification model may involve making the model available to the application gateways for use in traffic filtering. The model may then be applied as discussed with respect to the method 1000 shown in FIG. 10.

Prediction is scheduled and executed for bucketed data at 916. According to various embodiments, such periodic prediction may provide insights regarding IP threat intelligence, model performance over time, or other such considerations. For instance, such prediction may be performed once per hour or at another interval. Such periodic prediction may be used to generate additional signatures for filtering, as discussed with respect to the method 1000 shown in FIG. 1000.

FIG. 10 illustrates a method 1000 of applying a trained traffic classification model, performed in accordance with one or more embodiments. The method 1000 may be performed at the computing system 200 shown in FIG. 2. For instance, the method 1000 may be performed periodically, such as once per hour for a domain.

A request to apply a trained traffic classification model to a batch of application-layer request messages sent to a domain and received at an application gateway is received at 1002. According to various embodiments, such bucketed data aggregated periodically based on one or more criteria and dumped to a data store. For instance, such data may be aggregated once per hour or according to a different cadence.

In some embodiments, a subset of traffic may be selected for storage to the data store. For instance, a top-K criterion may be used to select common traffic patterns for periodic analysis via the machine learning model.

An application-layer request message from the batch is selected for analysis at 1004. According to various embodiments, the application-layer request messages may be analyzed in parallel or in any suitable order.

One or more fingerprint values for the application-layer request message are determined at 1006. According to various embodiments, the one or more fingerprint values may be determined in the same manner used to determine the training data used to train the traffic classification model.

The trained traffic classification model is applied to the one or more fingerprint values at 1008. According to various embodiments, the specific operations for applying the trained classification model to the fingerprint values may depend on the specific type of classification model employed. Regardless of the model type, however, the application of the trained classification model to the fingerprint values may yield an indication as to whether the application-layer request message is classified as malicious, at 1008.

In some embodiments, the trained traffic classification model may be applied to the one or more fingerprint values in parallel. For example, weights may then be read from an ensemble model, with the model state read and loaded into memory. The model may then be fitted to the bucketed data.

At 1010, a determination is made as to whether the traffic classification model classifies the application-layer request message as malicious. Upon determining that the message is classified as malicious, the one or more fingerprint values are stored at 1012 for use in traffic filtering.

In some embodiments, IP threat intelligence may be determined based on the classification data. Alternatively, or additionally, the PageRank algorithm or another processing algorithm may be calculated on a bipartite graph of fingerprints vs. IP addresses.

In some embodiments, the outcome values may be stored regardless of whether the request message is identified as malicious. For instance, the predicted classifications may then be stored in a data structure such as the following:

buckets”: { {“time”: 00.00, “fps”:[“fp5”, “fp6”]}, {“time”: 00.15, “fps”:[“fp7”, “fp8”]}}
“predict”:{{
“time”: t, “ensemble_id”: 01, “class_good”: [“fp5”, “fp7”], “class_bad”: [“fp6”, “fp8”]
“time”: t, “ensemble_id”: 02, “class_good”: [“fp8”], “class_bad”: [“fp5”, “fp6”, “fp7”]}}

At 1014, a determination is made as to whether to select an additional application-layer request message for analysis. According to various embodiments, additional request messages may continue to be selected until the available messages have been analyzed.

Upon determining not to select an additional application-layer request message for analysis, some or all of the one or more fingerprint values are deployed for traffic filtering at 1016. According to various embodiments, fingerprint values corresponding to traffic identified as malicious may be selected for deployment using any of various criteria. For example, fingerprints associated with traffic identified as malicious with a relatively higher confidence score may be more likely to be deployed for traffic filtering. As another example, fingerprints associated with traffic received at higher volume and/or more recently may be more likely to be deployed for traffic filtering.

FIG. 11 illustrates a method 1100 of filtering traffic based, performed in accordance with one or more embodiments. The method 1200 may be performed at the computing system 200 shown in FIG. 2 upon receive of an application-layer request message.

A request is received at 1102 to evaluate an application-layer request message directed to a domain and received at an application gateway. In some embodiments, the request may be generated when the request is processed by the fingerprint traffic filter 210 shown in FIG. 2.

One or more request fingerprints for the application-layer request message are determined at 1104. In some embodiments, the one or more request fingerprints may be determined in the same manner as used to determine the fingerprint values at 1006.

A determination is made at 1106 as to whether the one or more request fingerprints match the one or more filter fingerprints. In some embodiments, an exact match may be performed. Alternatively, in some configurations a fuzzy match may be sufficient to identify a match. A fuzzy match may be determined based on edit distance and/or any other suitable fuzzy matching criteria.

Upon determining that the one or more fingerprints match, the request message is rejected at 1008. Upon determining instead that the one or more fingerprints do not match, the request message is accepted at 1110. Accepting the request message may involve, for instance, forwarding the request message to the designated recipient, such as an application server.

### Fingerprint Configuration and Determination

According to various embodiments, any of various types and combinations of fingerprints may be employed in conjunction with techniques and mechanisms described herein. Examples of such fingerprints may include, but are not limited to: locality-based fingerprints, entropy-based fingerprints, content-based fingerprints, and unified fingerprints. The determination of such fingerprints is discussed in additional detail within this section, but the techniques and mechanisms described herein are generally applicable to a wide range of fingerprint configurations.

According to various embodiments, one or more of various traffic features may be used for fingerprinting. Examples of such features may include, but are not limited to: user-agent, URI, request method, request path, requested server name, response code, and/or portions of or combinations thereof. However, application-level request messages such as HTTP requests can include various types and combinations of traffic features. Some such traffic features may vary depending on the communication request specification and/or application-level communication specification. Thus, the term “traffic feature” may encompass any content, such as a key/value pair, included in the request message.

Locality-based Fingerprints. According to various embodiments, one or more of the fingerprints may be locality-based. Locality-based fingerprints may be produced by a hash function that yields similar or identical hash function output values for similar hash function input values. For the purpose of illustration, techniques and mechanisms are described herein with reference to a type of locality-based fingerprints called MinHash. However, in practice, any of various-types of locality-based fingerprints may be used.

According to various embodiments, the MinHash is a probabilistic technique and data structure used to efficiently estimate the similarity between two sets. Specifically, MinHash provides an approximation of the Jaccard similarity between two sets without needing to explicitly compute their intersection and union. For two sets A and B, the Jaccard similarity is defined as:

$$J ( A , B ) = ( ( A ∩ B ) / ( A ⋃ B ) )$$

MinHash approximates J(A, B) using signatures (called MinHash signatures), which are much smaller than the original sets. The computation is both fast and memory-efficient. If the elements of A and B are randomly permuted, the probability that the minimum element in the permutation is the same for both sets is equal to their Jaccard similarity. That is:

$$P ( min ( A ) = min ( B ) ) = J ( A , B )$$

Conceptually, the more elements two sets share, the more likely they are to share the smallest element under a random permutation. Computing actual random permutations of large sets is impractical. Instead, hash functions may be used to simulate random permutations. For an element x, the hash value h(x) determines its order in the simulated permutation. For a hash function h(x), let

$$min ( h ( A ) ) = min ( h ( x ) \vert x ∈ A )$$

Then, the probability that min(h(A))=min(h(B)) is equal to J(A, B).

In some embodiments, the estimate's accuracy may be improved by using multiple independent hash functions h₁(x) . . . hₖ(x). For each hash function, the MinHash (referred to herein as MH) min(h₁(x)) . . . min(hₖ(x)) can be computed. The fraction of hash functions for which min(hᵢ(x))=min(h₁(B)) then gives an estimate for J(A, B).

According to various embodiments, MinHash fingerprints may be determined for various traffic features such as User-Agent, Server Name, and Request Path. The MinHash may then be used to detect similar values for such traffic features, since pairs of similar input values may map to pairs of similar or even identical output values. The MinHash may be defined as follows.

In some embodiments, a MinHash fingerprint is a vector of hash values obtained using multiple independent hash functions. Let h₁(x) . . . hₖ(x) be k independent hash functions. Let F be the set of traffic features of interest (e.g., User-Agent, Server Name, Request Path). Let f∈F be a specific traffic feature. Let MinHashᵢ(f) denote the i-th MinHash value for feature f. Then, the MinHash fingerprint for a traffic feature f is defined as a vector of k MinHash values, where, n-grams(f) represents the set of n-grams generated from the feature f:

$$MH ( f ) = ( Min {Hash}_{1} ( f ) … Min {Hash}_{k} ( f ) ) \\ Min {Hash}_{i} ( f ) = min \{ {h}_{i} ( x ) \vert x ∈ n - grams ( f ) \}$$

According to various embodiments, the following are examples of various MinHash-based fingerprints. For example, let f_{UA} be the User-Agent feature. Then, the MinHash fingerprint for the User-Agent is MinHash(f_{UA})=(MinHash₁(f_{UA}) . . . MinHashₖ(f_{UA})). For example, let f_{SN} be a Server Name feature. In this case, the MinHash fingerprint for the Server Name is MinHash(f_{SN})=(MinHash₁(f_{SN}) . . . MinHashₖ(f_{SN}). As yet another example, let f_{RP} be the Request Path feature. Then, the MinHash fingerprint for the Request Path is MinHash(f_{RP})=(MinHash₁(f_{RP}) . . . MinHashₖ(f_{RP}). In this way, locality-based fingerprints may be quickly computed for various features.

Consider the following example, for a string “Mozilla” in a traffic feature. First, the string can be separated into 3-grams: [“Moz”, “ozi”, “zil”, “ill”, “lla”]. Then, multiple independent hash functions are run to compute hash values for each n-gram. A diverse set of hash functions and hash values may provide for a better approximation. For each hash function, the MinHash is computed as the minimum hash value of the n-grams. The vector of minimum hash values then represents the fingerprint. For example, the first value of the vector is min{h1(“Moz”), . . . , h1(“lla”)}.

Entropy-based Fingerprints. According to various embodiments, one or more of the fingerprints may be entropy-based. Entropy-based fingerprints may measure the randomness or uncertainty in a given traffic feature. For the purpose of illustration, techniques and mechanisms are described herein with reference to HX fingerprints that utilize Shannon entropy, which quantifies the amount of unpredictability or information content in the traffic feature. However, in practice, any of various-types of entropy-based fingerprints may be used. Entropy fingerprints facilitate detection of casual or automated requests by measuring the randomness in traffic features.

In some embodiments, entropy may be computed over the n-grams generated from a traffic feature. For instance, let F be the set of traffic features of interest (e.g., User-Agent, Server Name, Request Path, etc.). Let f∈F be a specific traffic feature. Let n-grams(f) represent the set of n-grams generated from the feature f. Then, the HX fingerprint for a traffic feature f is the Shannon entropy computed over the n-grams of the feature, where x; are the N unique n-grams in the feature f, p(xᵢ) is the probability of occurrence of an n-gram xᵢ in the feature f, count(xᵢ) is the number of times n-gram xᵢ appears in the feature f, and

$${\sum }_{j = 1}^{N} count ( {x}_{j} )$$

is the total number of times each unique n-gram appears in the feature f.

$$HX ( f ) = - {\sum }_{i = 1}^{N} p ( {x}_{i} ) {log}_{2} p ( {x}_{i} ) \\ p ( {x}_{i} ) = \frac{count ( {x}_{i} )}{{\sum }_{j = 1}^{N} count ( {x}_{j} )}$$

According to various embodiments, the following is an example of an entropy-based fingerprint. For example, let f_{UA} be the User-Agent feature. Then, the HX fingerprint for the User-Agent is

$$HX ( {f}_{UA} ) = - {\sum }_{i = 1}^{N} p ( {x}_{{UA}_{i}} ) {log}_{2} p ( {x}_{{UA}_{i}} )$$

where x_{UA}_{ᵢ} are the unique n-grams in the feature f_{UA}. As another example, let f_{SN} be the Server Name feature. Then, the HX fingerprint for the Server Name is

$$HX ( {f}_{SN} ) = - {\sum }_{i = 1}^{N} p ( {x}_{{SN}_{i}} ) {log}_{2} p ( {x}_{{SN}_{i}} )$$

where x_{UA}_{ᵢ} are the unique n-grams in the feature f_{SN}. As yet another example, let f_{RP} be the Request Path feature. Then, the HX fingerprint for the Request Path e is

$$HX ( {f}_{RP} ) = - {\sum }_{i = 1}^{N} p ( {x}_{{RP}_{i}} ) {log}_{2} p ( {x}_{{RP}_{i}} )$$

where x_{UA}_{ᵢ} are the unique n-grams in the feature f_{RP}.

As an additional example, consider the calculation of entropy fingerprints for a User Agent feature portion that includes the string “Mozilla.” First, in the Shingling phase, n-grams can be calculated. For this substring, the 1-grams would be [“M”, “o”, “z”, “l”, “l”, “a”]. Then, the frequency of each n-gram may be determined so as to calculate the probability of its occurrence. For instance, the probability of “l” if randomly drawn from the set of n-grams would be 2/7. Next, the sum of the product of the probabilities of each n-gram and the logarithm of its probabilities is determined. The entropy value represents the fingerprint, so HX(“Mozilla”)=−(1/7*log(1/7))+(1/7*log(1/7))+(1/7*log(1/7))+(1/7*log(1/7))+(2/7*log(1/7))+(1/7*log(1/7))=2.5219, with the logs calculated in base 2.

Content-based Fingerprints. In some embodiments, content-based (“CB”) fingerprints may be derived directly from specific traffic features such as the HTTP method, protocol, and response code. The content-based fingerprint for a traffic feature f may be implemented as the string representation of the feature itself. Truncation to a substring may be used to reduce the cardinality of the data. Alternatively, or additionally, recurring strings and/or substrings may be substituted for specific values, for instance to reduce storage space. Content-based fingerprints can be treated as categorical variables in the machine learning model.

According to various embodiments, examples of content-based fingerprints are as follows. Let F be the set of traffic features of interest (e.g., HTTP Method, Protocol, Response Code, etc.). Let f∈F be a specific traffic feature. For example, if f_{method}=POST is the HTTP Method feature, then the content-based fingerprint may be CB(f_{method})=POST. As another example, if f_{protocol}=HTTP/1.1 is the Protocol feature, then the content-based fingerprint may be CB(f_{protocol})=HTTP/1.1. As yet another example, if f_{code}=404 is the Code feature, then the content-based fingerprint may be CB(f_{code})=404.

Unified Fingerprints. In some embodiments, different fingerprints and different types of fingerprints may be combined into a unified fingerprint. In some implementations, without loss of generality, a unified fingerprint can be created by combining component fingerprints for any set of parameters. For example, a unified fingerprint may be created by combining component fingerprints as follows: FP_{Request}=HX(f_{UA}), HX(f_{SN}), HX(f_{UA}), MH(f_{UA}), MH(f_{SN}), MH(f_{UA}), CB(f_{method}), CB(f_{protocol}), CB(f_{code}).

In some embodiments, two or more component fingerprints may be combined to create a unified fingerprint. Alternatively, or additionally, a unified fingerprint may be representative as a dictionary. For example, let the following be an example request:

{‘protocol’: ‘HTTP/1.1’,
‘request_method’: ‘POST’,
‘request_path’: ‘/wp-json/click5_sitemap/API/update_html_option_AJAX’,
‘requested_server_name’: ‘2461-dev-ed.my.salesforce-scrt.com’,
‘response_code’: 404,
‘user-agent’: ‘Mozilla/5.0 (Macintosh; Intel Mac OS X 10_15_7) AppleWebKit/605.1.15

In this case, the unified fingerprint can be represented as a dictionary as follows.

```
{‘hx_request_path’: 4.49, # HX(f_RP)
  ‘hx_requested_server_name’: 4.05, # HX(f_SN)
  ‘hx_user_agent’: 5.07, # HX(f_UA)
  ‘mh_request_path_0’: 40923644, # MH(f_RP) MinHash_1(f_RP)
  ‘mh_request_path_1’: 110649632, # MH(f_RP) MinHash_2(f_RP)
  ‘mh_requested_server_name_0’: 19678434, # MH(f_SN) MinHash_1(f_SN)
  ‘mh_requested_server_name_1’: 90710011, # MH(f_SN) MinHash_2(f_SN)
  ‘mh_user_agent_0’: 57340411, # MH(f_UA) MinHash_1(f_UA)
  ‘mh_user_agent_1’: 20039035, # MH(f_UA) MinHash_2(f_UA)
  ‘cb_protocol’: ‘HTTP/1.1’, # CB(f_protocol)
  ‘cb_request_method’: ‘POST’, # CB(f_method)
```

In this example, k=2 is the number of hash functions for the MinHash fingerprints, the entropy has been computed using 1-grams, the logarithm base is 2, and the MinHash has been computed using 3-grams. However, in practice, other combinations of configuration parameters may be used.

To demonstrate the efficacy of the disclosed techniques configured in accordance with one or more embodiments, the model was run using 4,000 lines of legitimate and suspicious traffic. The MinHash was configured to use 8 different permutations. The example combined fingerprint described above combining HX, MH, and CB Fingerprints was used as the model parameters. The test sample size was chosen to be 30% of the total samples. In this example, the resulting confusion matrix and classification report were as follows. The HX and MH fingerprints accounted for 45% of the total importance, contributing to the model's 99% accuracy.

### Confusion Matrix:

| | |
|---|---|
| 1183 | 23 |
| 2 | 1192 |

### Classification Report:

| | Precision | Recall | F1-score | Support |
|---|---|---|---|---|
| 0 - Legitimate | 1.00 | 0.98 | 0.99 | 1206 |
| 1 - Suspicious | 0.98 | 1.00 | 0.99 | 1194 |
| Accuracy | | | 0.99 | 2400 |
| Macro Avg. | 0.99 | 0.99 | 0.99 | 2400 |
| Weighted Avg. | 0.99 | 0.99 | 0.99 | 2400 |

### Hybrid Quantum-Classical Botnet Traffic Classification

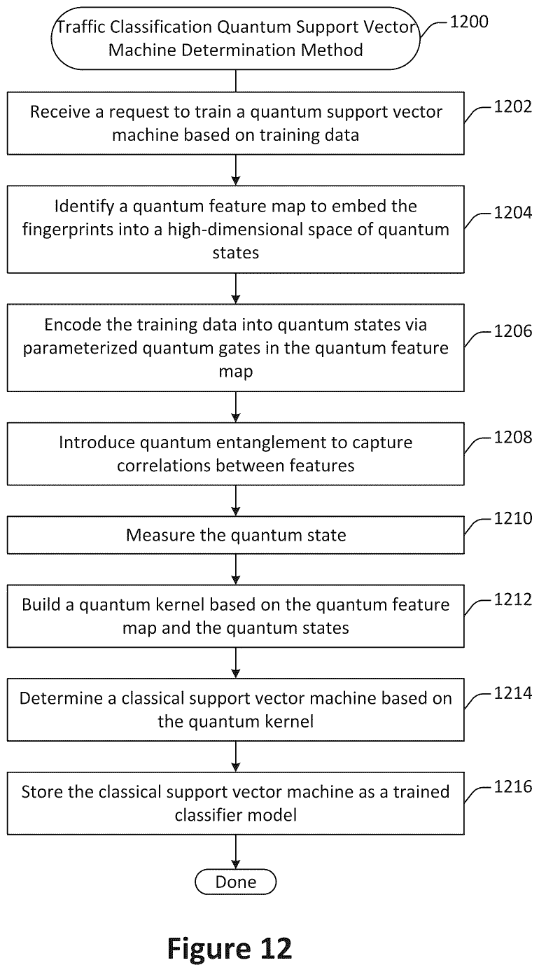

FIG. 12 illustrates a method 1200 for determining a traffic classification support vector machine, performed in accordance with one or more embodiments. The method 1200 may be performed at the computing system 200 shown in FIG. 2.

A request to train a quantum support vector machine based on training data is received at 1202. In some embodiments, the request may be generated as discussed with respect to operation 906 shown in FIG. 9.

A quantum feature map to embed the fingerprints into a high-dimensional space of quantum states is identified at 1204. In classical machine learning, a feature map transforms input data x into a higher-dimensional feature space. For example, φ: Rⁿ→R^{m}, m>n. A quantum feature map encodes classical data into a quantum state, which resides in a Hilbert space: φ:Rⁿ→H, where H is a Hilbert-space of quantum states. Each qubit in a quantum system can exist in a superposition of two basic states: |ψ [symbol] =α₀|0 [symbol] +α₁|1 [symbol] . For a system of N qubits, the feature space grows exponentially: H=span({|00 . . . 0 [symbol] , 00 . . . 1 [symbol] , . . . , |11 . . . 1 [symbol] }). Accordingly, N qubits encode data in a 2\hat{ }N-dimensional Hilbert space, which is exponentially larger than a classical feature space of dimension N.

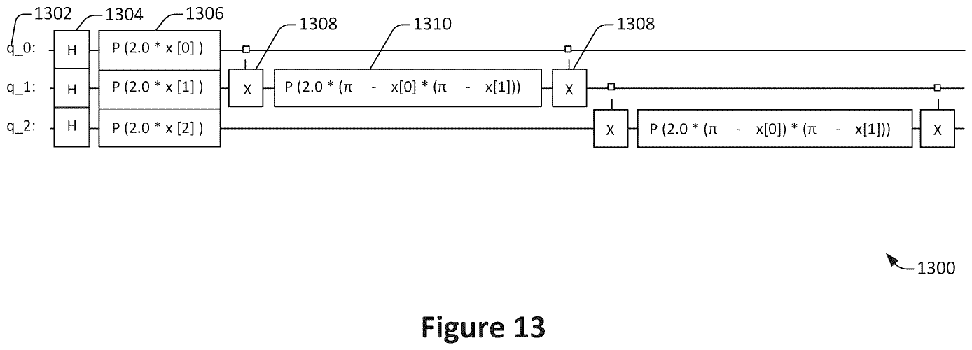

FIG. 13 illustrates a quantum feature map 1300, configured in accordance with one or more embodiments. The quantum feature map 1300 includes three qubits 1302. In some embodiments, to create the quantum feature map 1300, each of the qubits is initialized with a respective Hadamard gate 1304, which puts the qubits into a superposition state. Each qubit then undergoes a parameterized phase gate 1306, which applies a phase shift based on the input features x[0], x[1], and x[2] corresponding to the qubits. The qubits are then entangled using parameterized ZZ interactions. In some embodiments, the parameterized ZZ interactions may be implemented using a sequence of CNOT gates 1308 and a phase gate 1310.

According to various embodiments, the CNOT gates 1308 may be used to create the controlled-Z gates. The phase gate 1310 may apply a phase shift based on the product of the features.

In some embodiments, as shown in FIG. 13, linear entanglement is used. In linear entanglement, each qubit is entangled only with its immediate neighbor(s). However, in other configurations, other types of entanglement may be used.

The quantum feature map 1300 includes only three qubits to avoid unnecessarily obscuring the inventive concepts. However, in some embodiments, a quantum feature map may include potentially many qubits. Further, the quantum feature map 1300 is configured in a particular manner. However, in some embodiments a quantum feature map may be configured in a different manner while remaining consistent with techniques and mechanisms described herein.

The training data including the fingerprints is encoded into the quantum states via parameterized quantum gates in the quantum feature map at 1206. Quantum entanglement is introduced to capture correlations between features at 1208. The quantum state is measured at 1210.

At 1212, a quantum kernel based on the quantum feature map and the quantum states is built. In some embodiments, the quantum kernel measures the fidelity between quantum states corresponding to different input samples. For example, the quantum kernel may be computed as the following, where φ(\vec{xₗ}) is the quantum state produced by the feature map and | [symbol] a|b) [symbol] |² denotes the overlap (i.e., the fidelity) of two quantum states a and b.

$$K ( {x}_{i} , {x}_{j} ) = {\vert 〈 ϕ ( \vec{{x}_{ι}} ) \vert ϕ ( \vec{{x}_{J}} ) 〉 \vert}^{2}$$

A classical support vector machine is determined at 1214 based on the quantum kernel. In some embodiments, the quantum kernel may be evaluated in quantum space to determine a quantum kernel that may then be used to classical space. The quantum kernel may then be provided as an input kernel to initialize a support vector machine.

The classical support vector machine is stored as a trained classifier model at 1216. In some embodiments, the classical support vector machine may be stored in the database system. The classical support vector machine may then be published to one or more application gateways and used for classifying an application-layer request message as malicious or not malicious without needing to perform further quantum calculations.

In some embodiments, one or more of the operations 1204 through 1214 may be performed at least in part using a library, such as qiskit for Python. For instance, the following code portion provides a simple example of the types of operations that may be performed to determine a trained quantum-classical support vector machine, in accordance with one or more embodiments. Code written with such a model may be executed in simulation on a quantum processor or on a classical processor, albeit at significantly lower speed on the classical processor.

For the purpose of illustration, the following code portions illustrate examples of how to determine a hybrid quantum-classical SVM in accordance with one or more embodiments. To avoid unnecessarily obscuring the inventive concepts, the following examples are simple in nature. For example, different examples are provided for MinHash and entropy-based fingerprints. In practice, however, various types and combinations of fingerprints may be used.

```
        Hybrid Quantum-Classical Botnet Traffic Classification Implementation: Entropy
  import numpy as np
  import pandas as pd
  from scipy.stats import entropy
  from qiskit import QuantumCircuit, transpile
  from qiskit_aer import AerSimulator
  from sklearn.svm import SVC
  from qiskit.circuit.library import ZZFeatureMap
  from qiskit_machine_learning.kernels import FidelityQuantumKernel
  from qiskit.primitives import StatevectorSampler as Sampler
  from qiskit_machine_learning.state_fidelities import ComputeUncompute
  from sklearn.model_selection import train_test_split
  from sklearn.metrics import accuracy_score, classification_report, confusion_matrix
  from collections import Counter
  # ** Parse CSV Logs**
  def parse_csv(file_path, nrows=150):
    df = pd.read_csv(file_path, nrows=nrows)
    df.fillna(“”, inplace=True)
    return df.to_dict(orient=“records”), (1 if “suspicious” in file_path else 0)
  # ** Compute Shannon Entropy**
  def shannon_entropy(field_value, ngram_size=1):
    if not field_value:
      return 0.0 # Default entropy for empty values
    ngrams = [field_value[i:i+ngram_size] for i in range(len(field_value) − ngram_size + 1)]
    freq_dist = Counter(ngrams)
    probabilities = np.array(list(freq_dist.values( ))) / sum(freq_dist.values( ))
    return entropy(probabilities, base=2)
  # ** Preprocess Logs for Quantum Encoding**
  def preprocess_logs(logs, label):
    features = [ ]
    labels = [ ]
    for log in logs:
      requested_server_name = log.get(“requested_server_name”, “”)
      request_path = log.get(“request_path”, “”)
      user_agent = log.get(“user-agent”, “”)
      entropy_vector = [
        shannon_entropy(requested_server_name, 1), # 1-gram entropy
        shannon_entropy(requested_server_name, 2), # 2-gram entropy
        shannon_entropy(request_path, 1),
        shannon_entropy(request_path, 2),
        shannon_entropy(user_agent, 1),
        shannon_entropy(user_agent, 2)
      ]
      # Apply min-max scaling and L2 normalization
      # entropy_vector = np.array(entropy_vector)
      # norm_hash_values = (entropy_vector − np.min(entropy_vector)) /
(np.max(entropy_vector) − np.min(entropy_vector) + 1e−10)
      # norm = np.linalg.norm(norm_hash_values)
      # normalized_vector = (norm_hash_values / norm) if norm != 0 else
np.zeros(len(entropy_vector))
      # Apply min-max scaling and L2 normalization
      entropy_vector = np.array(entropy_vector)
      norm = np.linalg.norm(entropy_vector)
      normalized_vector = (entropy_vector / norm) if norm != 0 else
np.zeros(len(entropy_vector))
      features.append(normalized_vector)
      labels.append(label)
    return np.array(features), np.array(labels)
  # ** Create QSVC Model with Quantum Kernel**
  def create_svc(feature_dimension):
    feature_map = ZZFeatureMap(feature_dimension, reps=2, entanglement=‘full’)
    sampler = Sampler( )
    fidelity = ComputeUncompute(sampler=sampler)
    quantum_kernel = FidelityQuantumKernel(fidelity=fidelity,
feature_map=feature_map)
    svc = SVC(kernel=quantum_kernel.evaluate)
    return svc
  # ** Train and Evaluate with QSVC**
  def train_and_evaluate(X, y, svc):
    X_train, X_test, y_train, y_test = train_test_split(X, y, test_size=0.3, random_state=42)
    svc.fit(X_train, y_train)
    y_pred = svc.predict(X_test)
    accuracy = accuracy_score(y_test, y_pred)
    print(f“Accuracy: {accuracy:.4f}”)
    print(“\nConfusion Matrix:”)
    print(confusion_matrix(y_test, y_pred))
    print(“\nClassification Report:”)
    print(classification_report(y_test, y_pred))
  # ** Main Execution**
  legitimate_file = “20241230_legitimate.csv”
  suspicious_file = “20241230_suspicious_noroot.csv”
  legitimate_logs, legitimate_label = parse_csv(legitimate_file)
  suspicious_logs, suspicious_label = parse_csv(suspicious_file)
  all_logs = legitimate_logs + suspicious_logs
  labels = np.array([0] * len(legitimate_logs) + [1] * len(suspicious_logs))
  # Extract Shannon Entropy Features
  features_legitimate, _ = preprocess_logs(legitimate_logs, 0)
  features_suspicious, _ = preprocess_logs(suspicious_logs, 1)
  features = np.vstack((features_legitimate, features_suspicious))
  # Create QSVC Model
  svc = create_svc(6)
  # Train and Evaluate the Model
  train_and_evaluate(features, labels, svc)
        Hybrid Quantum-Classical Botnet Traffic Classification Implementation: MinHash
  import numpy as np
  import pandas as pd
  from datasketch import MinHash
  from qiskit import QuantumCircuit, transpile
  from qiskit_aer import AerSimulator
  from sklearn.svm import SVC
  from qiskit.circuit.library import ZZFeatureMap
  from qiskit_machine_learning.kernels import FidelityQuantumKernel
  from qiskit.circuit.library import ZZFeatureMap
  from qiskit.primitives import StatevectorSampler as Sampler
  from qiskit_machine_learning.state_fidelities import ComputeUncompute
  from sklearn.model_selection import train_test_split
  from sklearn.metrics import accuracy_score, classification_report, confusion_matrix
  # ** Parse CSV Logs**
  def parse_csv(file_path, nrows=150):
    df = pd.read_csv(file_path, nrows=nrows)
    df.fillna(“”, inplace=True)
    return df.to_dict(orient=“records”), (1 if “suspicious” in file_path else 0)
  # ** Compute MinHash for User-Agent**
  def compute_minhash(field_value, num_perm=8):
    if not field_value:
      return [0] * num_perm # Default fingerprint for empty values
    minhash = MinHash(num_perm=num_perm)
    for shingle in [field_value[i:i+3] for i in range(len(field_value)−2)]: # Generate 3-grams
      minhash.update(shingle.encode(‘utf8’))
    return minhash.digest( )
  # ** Preprocess Logs for Quantum Encoding**
  def preprocess_logs(logs, label):
    features = [ ]
    labels = [ ]
    for log in logs:
      user_agent = log.get(“user-agent”, “”)
      minhash_vector = compute_minhash(user_agent)
      # Apply min-max scaling and L2 normalization
      minhash_vector = np.array(minhash_vector)
      norm_hash_values = (minhash_vector − np.min(minhash_vector)) /
(np.max(minhash_vector) − np.min(minhash_vector) + 1e−10)
      norm = np.linalg.norm(norm_hash_values)
      normalized_vector = (norm_hash_values / norm) if norm != 0 else
np.zeros(len(minhash_vector))
      features.append(normalized_vector)
      labels.append(label)
    return np.array(features), np.array(labels)
  # ** Create QSVC Model with Quantum Kernel**
  def create_svc(feature_dimension=8):
    feature_map = ZZFeatureMap(feature_dimension, reps=2, entanglement=‘full’)
    sampler = Sampler( )
    fidelity = ComputeUncompute(sampler=sampler)
    quantum_kernel = FidelityQuantumKernel(fidelity=fidelity,
feature_map=feature_map)
    # quantum_kernel = FidelityQuantumKernel( )
    svc = SVC(kernel=quantum_kernel.evaluate)
    return svc
  # ** Train and Evaluate with QSVC**
  def train_and_evaluate(X, y, svc):
    X_train, X_test, y_train, y_test = train_test_split(X, y, test_size=0.3, random_state=42)
    svc.fit(X_train, y_train)
    y_pred = svc.predict(X_test)
    accuracy = accuracy_score(y_test, y_pred)
    print(f“Accuracy: {accuracy:.4f}”)
    print(“\nConfusion Matrix:”)
    print(confusion_matrix(y_test, y_pred))
    print(“\nClassification Report:”)
    print(classification_report(y_test, y_pred))
  # ** Main Execution**
  legitimate_file = “20241230_legitimate.csv”
  suspicious_file = “20241230_suspicious_noroot.csv”
  legitimate_logs, legitimate_label = parse_csv(legitimate_file)
  suspicious_logs, suspicious_label = parse_csv(suspicious_file)
  all_logs = legitimate_logs + suspicious_logs
  labels = np.array([0] * len(legitimate_logs) + [1] * len(suspicious_logs))
  # Extract MinHash Features
  features_legitimate, _ = preprocess_logs(legitimate_logs, 0)
  features_suspicious, _ = preprocess_logs(suspicious_logs, 1)
  features = np.vstack((features_legitimate, features_suspicious))
  # Create QSVC Model
  svc = create_svc( )
  # Train and Evaluate the Model
      train_and_evaluate(features, labels, svc)
```

To demonstrate the efficacy of the hybrid quantum-classical botnet traffic classification approach for entropy-based fingerprints, a simulation was performed using a simulated quantum computer. A quantum circuit with 6 qubits was used for the hybrid quantum-classical classification of entropy-based fingerprints. Each qubit was associated to one different value of entropy. The 6 entropies calculated were the Shannon entropies for the User-Agent, Server Name, and URL, both on the 1-grams and the 2-gram for a random sample of legitimate and suspicious requests. A feature map using 6 qubits, 2 repetitions and full entanglement was used. Classification results yielded an accuracy of 90%, despite reduced training data size due to the limitations implicit in running a quantum simulator. In this simple example, the hybrid-quantum-classical classification outperformed a classical support vector machine by 3% when classifying legitimate traffic and by 2% when classifying suspicious traffic.

### Confusion Matrix:

| | |
|---|---|
| 42 | 6 |
| 3 | 39 |

### Classification Report:

| | Precision | Recall | F1-score | Support |
|---|---|---|---|---|
| 0 | 0.93 | 0.88 | 0.90 | 48 |
| 1 | 0.87 | 0.93 | 0.90 | 42 |
| Accuracy | | | 0.90 | 90 |
| Macro Avg. | 0.90 | 0.90 | 0.90 | 90 |
| Weighted Avg. | 0.90 | 0.90 | 0.90 | 90 |

To demonstrate the efficacy of the hybrid quantum-classical botnet traffic classification approach for MinHash-based fingerprints, a simulation was performed using a simulated quantum computer. A quantum circuit with 8 qubits has been used for the hybrid quantum-classical classification of MinHash-based fingerprints.

The User-Agent MinHash fingerprint has been used to obtain a vector of size 8 which is then normalized and then mapped to a high-dimensional space via quantum feature mapping. A feature map using 6 qubits, 2 repetitions, and full entanglement was used. Classification results yielded an accuracy of 91%.

### Confusion Matrix:

| | |
|---|---|
| 40 | 8 |
| 0 | 42 |

### Classification Report:

| | Precision | Recall | F1-score | Support |
|---|---|---|---|---|
| 0 | 1.00 | 0.83 | 0.91 | 48 |
| 1 | 0.84 | 1.00 | 0.91 | 42 |
| Accuracy | | | 0.91 | 90 |
| Macro Avg. | 0.92 | 0.92 | 0.91 | 90 |
| Weighted Avg. | 0.93 | 0.91 | 0.91 | 90 |

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method implemented at a computing system. The method also includes determining a plurality of training data observations corresponding to a first plurality of application-layer request messages received at the computing system, the plurality of training data observations including first fingerprint values determined based on content associated with the first plurality of application-layer request messages, a first subset of the first plurality of application-layer request messages being classified as malicious, a second subset of the first plurality of application-layer request messages being classified as legitimate. The method also includes determining a trained machine learning model based on the plurality of training data observations. The method also includes applying the trained machine learning model to second fingerprint values corresponding to a second plurality of application-layer request messages to identify as malicious a subset of the second fingerprint values corresponding to a subset of the second plurality of application-layer request messages. The method also includes blocking an application-layer request message received at the computing system upon determining that the application-layer request message is associated with a designated fingerprint value matching one or more of the subset of the second fingerprint values. Other embodiments of this aspect include corresponding computer systems, apparatus, and computer programs recorded on one or more computer storage devices, each configured to perform the actions of the methods.

Implementations may include one or more of the following features. The method recited where the first subset of the first plurality of application-layer request messages were classified as malicious upon determining that they failed to comply with a communication specification governing application-layer request messages transmitted to the computing system. The second subset of the first plurality of application-layer request messages complied with the communication specification. The second subset of the first plurality of application-layer request messages were classified as legitimate upon determining that the computing system successfully fulfilled the second subset of the first plurality of application-layer request messages. The plurality of training data observations are specific to a domain of a plurality of domains accessible via the computing system, and where the application-layer request message is directed to the domain. The second fingerprint values include an entropy-based fingerprint value sensitive to uncertainty in data. The second fingerprint values include a locality-based fingerprint value that maps similar input values to similar output values. The second fingerprint values include a unified fingerprint value determined combining two or more input fingerprint values. The trained machine learning model is a support vector machine employing a quantum-classical kernel determined by mapping fingerprint values to a Hilbert space via a quantum feature map. Implementations of the described techniques may include hardware, a method or process, or computer software on a computer-accessible medium.

Another general aspect includes an application gateway within a computing services environment. The application gateway also includes a communication interface configured to receive a plurality of application-layer request messages directed to a domain accessible via the computing services environment. The gateway also includes a fingerprint database storing a plurality of predetermined filter fingerprint values. The gateway also includes a fingerprint engine configured to determine fingerprint information based on an application-layer request message of the plurality of application-layer request messages, the fingerprint information including a locality-based fingerprint determined based on a locality-sensitive hashing function that maps similar input values to similar output values, the fingerprint information including a entropy-based fingerprint sensitive to an amount of information stored in data. The gateway also includes a fingerprint filter configured to block the application-layer request message from being transmitted to a request destination upon determining that the fingerprint information matches a predetermined filter fingerprint value of the plurality of predetermined filter fingerprint values. Other embodiments of this aspect include corresponding computer systems, apparatus, and computer programs recorded on one or more computer storage devices, each configured to perform the actions of the methods.

Implementations may include one or more of the following features. The application gateway recited where the fingerprint information includes a unified fingerprint that combines the locality-based fingerprint and the entropy-based fingerprint. The unified fingerprint also combines a third fingerprint determined by truncating a traffic feature of the application-layer request message. The fingerprint information is determined based on traffic features selected from the group may include of: user-agent, server name, and uniform resource identifier. The locality-sensitive hashing function is a vector of minimum hash values obtained by applying a plurality of independent hash functions over a plurality of n-grams of a feature of the application-layer request message. The entropy-based fingerprint is shannon entropy computed over a plurality of n-grams of a feature of the application-layer request message. The fingerprint information includes a plurality of entropy-based fingerprints corresponding to a plurality of different traffic features of the application-layer request message, plurality of entropy-based fingerprints including the entropy-based fingerprint. The fingerprint information includes a plurality of locality-sensitive fingerprints corresponding to a plurality of different traffic features of the application-layer request message, plurality of locality-sensitive fingerprints including the locality-based fingerprint. Implementations of the described techniques may include hardware, a method or process, or computer software on a computer-accessible medium.

Another general aspect includes a method implemented at a computing system. The method also includes determining a plurality of training data observations corresponding to a plurality of application-layer request messages received at the computing system, the plurality of training data observations including a plurality of fingerprint values determined based on content associated with the plurality of application-layer request messages, a first subset of the plurality of application-layer request messages being classified as malicious, a second subset of the plurality of application-layer request messages being classified as legitimate. The method also includes determining a classical support vector machine based on a quantum kernel, the quantum kernel being determined based on a quantum feature map and a plurality of quantum states, the quantum feature map embedding the plurality of fingerprint values into a quantum space corresponding to the quantum states. The method also includes determining a fingerprint value for an application-layer request message received at an application gateway within the computing system. The method also includes blocking the application-layer request message from reaching a destination within the computing system based on the fingerprint value and a classification performed by the classical support vector machine. Other embodiments of this aspect include corresponding computer systems, apparatus, and computer programs recorded on one or more computer storage devices, each configured to perform the actions of the methods.

Implementations may include one or more of the following features. The method recited where a fingerprint value in the plurality of fingerprint values has a first dimension, and where the quantum space has a second dimension greater than the first dimension. The method recited the method may include: applying the classical support vector machine to the fingerprint value to determine an indication that the application-layer request message is classified as malicious. The method recited the method may include: determining a batch of fingerprint values corresponding to a batch of application-layer request messages; and applying the classical support vector machine to the batch of fingerprint values to determine a plurality of classification values, a first subset of the plurality of classification values identifying a first subset of the batch of application-layer request messages as malicious, a second subset of the plurality of classification values identifying a second subset of the batch of application-layer request messages as malicious, the first subset of batch of application-layer request messages corresponding to a first subset of the batch of fingerprint values, the second subset of batch of application-layer request messages corresponding to a second subset of the batch of fingerprint values. The fingerprint value matches a corresponding fingerprint value in the first subset of the batch of fingerprint values. The fingerprint value exactly matches the corresponding fingerprint value. The fingerprint value matches the corresponding fingerprint value with a similarity that exceeds a designated threshold. The plurality of training data observations are specific to a domain of a plurality of domains accessible via the computing system, and where the application-layer request message is directed to the domain. All or a portion of the fingerprint value is an entropy-based fingerprint value sensitive to uncertainty in data. All or a portion of the fingerprint value is a locality-based fingerprint value that maps similar input values to similar output values. The method recited all or a portion of the fingerprint value is a unified fingerprint value determined by combining two or more input fingerprint values. Implementations of the described techniques may include hardware, a method or process, or computer software on a computer-accessible medium.

### CONCLUSION

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of application-level distributed denial of service attacks. However, the techniques disclosed herein apply to a wide variety of malicious network activity. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method implemented at a computing system, the method comprising:
determining a plurality of training data observations corresponding to a plurality of application-layer request messages received at the computing system, the plurality of training data observations including a plurality of fingerprint values determined based on content associated with the plurality of application-layer request messages, a first subset of the plurality of application-layer request messages being classified as malicious, a second subset of the plurality of application-layer request messages being classified as legitimate;
determining a classical support vector machine based on a quantum kernel, the quantum kernel being determined based on a quantum feature map and a plurality of quantum states, the quantum feature map embedding the plurality of fingerprint values into a quantum space corresponding to the quantum states;
determining a fingerprint value for an application-layer request message received at an application gateway within the computing system; and
blocking the application-layer request message from reaching a destination within the computing system based on the fingerprint value and a classification performed by the classical support vector machine.

2. The method recited in claim 1, wherein a fingerprint value in the plurality of fingerprint values has a first dimension, and wherein the quantum space has a second dimension greater than the first dimension.

3. The method recited in claim 1, the method further comprising:
applying the classical support vector machine to the fingerprint value to determine an indication that the application-layer request message is classified as malicious.

4. The method recited in claim 1, the method further comprising:
determining a batch of fingerprint values corresponding to a batch of application-layer request messages; and
applying the classical support vector machine to the batch of fingerprint values to determine a plurality of classification values, a first subset of the plurality of classification values identifying a first subset of the batch of application-layer request messages as malicious, a second subset of the plurality of classification values identifying a second subset of the batch of application-layer request messages as malicious, the first subset of batch of application-layer request messages corresponding to a first subset of the batch of fingerprint values, the second subset of batch of application-layer request messages corresponding to a second subset of the batch of fingerprint values.

5. The method recited in claim 4, wherein the fingerprint value matches a corresponding fingerprint value in the first subset of the batch of fingerprint values.

6. The method recited in claim 5, wherein the fingerprint value exactly matches the corresponding fingerprint value.

7. The method recited in claim 5, wherein the fingerprint value matches the corresponding fingerprint value with a similarity that exceeds a designated threshold.

8. The method recited in claim 1, wherein the plurality of training data observations are specific to a domain of a plurality of domains accessible via the computing system, and wherein the application-layer request message is directed to the domain.

9. The method recited in claim 1, wherein all or a portion of the fingerprint value is an entropy-based fingerprint value sensitive to uncertainty in data.

10. The method recited in claim 1, wherein all or a portion of the fingerprint value is a locality-based fingerprint value that maps similar input values to similar output values.

11. The method recited in claim 1, all or a portion of the fingerprint value is a unified fingerprint value determined by combining two or more input fingerprint values.

12. A system configured to perform a method implemented at a computing system, the method comprising:
determining a plurality of training data observations corresponding to a plurality of application-layer request messages received at the computing system, the plurality of training data observations including a plurality of fingerprint values determined based on content associated with the plurality of application-layer request messages, a first subset of the plurality of application-layer request messages being classified as malicious, a second subset of the plurality of application-layer request messages being classified as legitimate;
determining a classical support vector machine based on a quantum kernel, the quantum kernel being determined based on a quantum feature map and a plurality of quantum states, the quantum feature map embedding the plurality of fingerprint values into a quantum space corresponding to the quantum states;
determining a fingerprint value for an application-layer request message received at an application gateway within the computing system; and
blocking the application-layer request message from reaching a destination within the computing system based on the fingerprint value and a classification performed by the classical support vector machine.

13. The system recited in claim 12, wherein a fingerprint value in the plurality of fingerprint values has a first dimension, and wherein the quantum space has a second dimension greater than the first dimension.

14. The system recited in claim 12, the method further comprising:
applying the classical support vector machine to the fingerprint value to determine an indication that the application-layer request message is classified as malicious.

15. The system recited in claim 12, the method further comprising:
determining a batch of fingerprint values corresponding to a batch of application-layer request messages; and
applying the classical support vector machine to the batch of fingerprint values to determine a plurality of classification values, a first subset of the plurality of classification values identifying a first subset of the batch of application-layer request messages as malicious, a second subset of the plurality of classification values identifying a second subset of the batch of application-layer request messages as malicious, the first subset of batch of application-layer request messages corresponding to a first subset of the batch of fingerprint values, the second subset of batch of application-layer request messages corresponding to a second subset of the batch of fingerprint values.

16. The system recited in claim 15, wherein the fingerprint value matches a corresponding fingerprint value in the first subset of the batch of fingerprint values.

17. The system recited in claim 15, wherein the plurality of training data observations are specific to a domain of a plurality of domains accessible via the computing system, and wherein the application-layer request message is directed to the domain.

18. The system recited in claim 15, wherein all or a portion of the fingerprint value is an entropy-based fingerprint value sensitive to uncertainty in data.

19. The system recited in claim 15, wherein all or a portion of the fingerprint value is a locality-based fingerprint value that maps similar input values to similar output values.

20. One or more non-transitory computer readable media having instructions stored thereon for performing a method implemented at a computing system, the method comprising:
determining a plurality of training data observations corresponding to a plurality of application-layer request messages received at the computing system, the plurality of training data observations including a plurality of fingerprint values determined based on content associated with the plurality of application-layer request messages, a first subset of the plurality of application-layer request messages being classified as malicious, a second subset of the plurality of application-layer request messages being classified as legitimate;
determining a classical support vector machine based on a quantum kernel, the quantum kernel being determined based on a quantum feature map and a plurality of quantum states, the quantum feature map embedding the plurality of fingerprint values into a quantum space corresponding to the quantum states;
determining a fingerprint value for an application-layer request message received at an application gateway within the computing system; and
blocking the application-layer request message from reaching a destination within the computing system based on the fingerprint value and a classification performed by the classical support vector machine.
